(19) United States
(12) Patent Application Publication
(10) Pub. No.: US 2026/0309318 A1
(43) Pub. Date: Oct. 8, 2026

(54) LUMINAIRE HAVING A BACK PLATE WITH OPENING FOR RELASABLY ATTACHED DRIVER

(71) Applicant: SIGNIFY HOLDING B.V., EINDHOVEN (NL)

(72) Inventors: PETER JOHANNES MARTINUS BUKKEMS, DEURNE (NL); BEREND JAN WILLEM TER WEEME, EINDHOVEN (NL); HENDRIKUS JOHAN ANDRIE DE VRIES, EINDHOVEN (NL); ANNA WILHELMINA MARIA DE BEST, EINDHOVEN (NL); OLIVER FRANCIS BURKE, EINDHOVEN (NL); MATHIJS RIEN DE SCHIPPER, EINDHOVEN (NL)

(21) Appl. No.: 19/481,377

(22) PCT Filed: Apr. 18, 2024
(86) PCT No.: PCT/EP2024/060510

§ 371 Date: Nov. 4, 2025

(30) Foreign Application Priority Data
May 4, 2023 (EP) 23171493.2

(51) Int. Cl. F21V 23/00; F21V 15/01; F21V 29/503; F21V 29/70

(52) U.S. Cl. CPC F21V 23/009; F21V 15/01; F21V 29/503; F21V 29/70

(57) ABSTRACT

The invention relates to a luminaire comprising one or more lighting modules, a driver for driving the one or more lighting modules, and a luminaire housing. The one or more lighting modules and the driver are arranged in the luminaire housing. The luminaire housing comprises a back plate constituting a back side of the luminaire housing. Each lighting module and the driver are releasably connected to the back plate. The back plate has an opening arranged to accommodate the driver. When connected to the back plate, the driver provides a closure of the opening. The luminaire may be used as a recessed luminaire in an office environment. It is convenient and non-complex in structure, and provides energy efficiency and sustainability.

### FIELD OF THE INVENTION

The invention relates to a luminaire comprising one or more lighting modules and a driver for driving the one or more lighting modules. The luminaire may be used as a recessed luminaire in an office environment.

### BACKGROUND OF THE INVENTION

The last decade has seen a shift in commercial building design. Office spaces, in particular, have evolved due to changes in how we work and what we expect from our workplace. They no longer can be designed according to functional requirements only; they need to deliver a pleasant experience for all who will occupy the space.

Commercial building lighting must follow suit and deliver a high degree of flexibility, to fit a range of designs and applications, and to support the diverse needs of building occupants and their activities in these spaces.

There is currently a large interest and need for lighting arrangements or luminaires which are convenient in their constructions, as it is desirable to a provide a robust assembly, convenient removal and/or re-installation of parts or components of the lighting arrangements or luminaires.

More specifically, recessed lighting arrangements or luminaires, which may be arranged in offices, homes, and stores, may comprise multiple lighting modules attached to a back plate. For luminaires of this kind, it is desirable that the individual lighting modules can be easily removed and re-installed, or that an installation or service of one or more components from the front side and/or the back side of the lighting device is facilitated.

It should be noted that the result of conveniently constructed lighting arrangements or luminaires encompasses an increased energy efficiency and sustainability.

More specifically, the possibility to repair and upgrade luminaires significantly increases the luminaire sustainability, and a modular design of the luminaires enables an easy replacement of luminaire parts or components thereof.

Prior art lighting arrangements, aiming to provide at least some of the above-mentioned advantages, are often complex and inconvenient in their constructions. Due to these deficiencies, they are consequently not able to achieve the sought energy efficiency and sustainability of the lighting arrangements.

It is an object of the invention to address the above, preferably without compromising efficacy, quality of light and aesthetic choice.

In other words, it is an object of the invention to provide a lighting arrangement or luminaire which is convenient and non-complex in its structure, which consequently also provides energy efficiency and sustainability.

### SUMMARY OF THE INVENTION

There is a desire to provide a lighting arrangement or luminaire which is convenient and non-complex in its construction or structure, resulting in an increased energy efficiency and sustainability of the lighting arrangement or luminaire due to a facilitated assembly, as well as removal, repair, and re-installation operations.

This and other objects are achieved by providing a luminaire having the features in the independent claim. Preferred embodiments are defined in the dependent claims.

Hence, according to a first aspect of the invention, there is provided a luminaire comprising one or more lighting modules, a driver for driving the one or more lighting modules, and a luminaire housing. The one or more lighting modules and the driver are arranged in the luminaire housing. The luminaire housing comprises a back plate constituting a back side of the luminaire housing. Each lighting module and the driver are releasably connected to the back plate. The back plate has an opening arranged to accommodate the driver. When connected to the back plate, the driver provides a closure of the opening.

The luminaire has a construction with a partially open back plate. When the driver is connected to the luminaire, its presence ensures a closure of the back plate so that the combination of both (back plate and driver) can serve as a fire resistant housing.

An important standard for safety luminaires is UL standard 1598. Part 12.4 of UL 1598 relates to recessed housing, and it specifies that such housings need to close the ceiling opening, and that only “small and few” holes are permitted.

For example, according to part 12.4 of UL 1598, a recessed housing of a luminaire that does not serve as an enclosure may have open holes, as long as the total area of all open holes is not more than 15 percent of the area of the opening in the mounting surface closed off by the recessed housing. For a non-IC rated luminaire, the open holes shall be a maximum of 9.5 mm wide and 10 cm² in area, and any other open hole shall not allow passage of a rod having a diameter of 25 mm and shall not exceed 10 cm² in area. For an IC rated luminaire, the open holes shall be a maximum of 4.8 mm wide and 10 cm² in area, and any other open hole shall not allow passage of a rod having a diameter of 6.4 mm and shall not exceed 10 cm² in area.

The construction of the luminaire according to the invention enables to fulfill these requirements, while saving material and cost.

The driver may comprise a driver housing, and the back plate and the driver housing may both be made from a metal.

The luminaire may further comprise a junction box, wherein the driver has a low-voltage side that can be connected to the back plate and a high-voltage side that can be connected to the junction box.

The driver may be kept in position by an assembly bridge, when the driver is connected to the back plate.

The assembly bridge may be arranged to prevent a drop of the driver when the low-voltage side of the driver is detached from the back plate.

The luminaire may comprise a plurality of lighting modules, each lighting module having a base substrate. The back plate may then have a plurality of dimples for aligning the plurality of lighting modules so that their base substrates are in a plane at a distance from the back plate. When a first lighting module of the plurality of lighting modules would then be arranged to cover the driver, the assembly bridge may be arranged to align the first lighting module so that the base substrate of the first lighting module is in the same plane. Additionally, or alternatively, the assembly bridge may be arranged to dissipate heat away from the first lighting module when the luminaire is in operation.

The luminaire may comprise a cover, wherein, when the driver is connected to the back plate, a first part at the low-voltage side is covered by the cover and a second part at the high-voltage side is inserted in the junction box. The cover, the junction box, and a remaining third part of the driver, located between the first part and the second part, may then together provide a closure of the opening.

At the low-voltage side, the driver may be arranged to be connected to the cover by means of a releasable connection, such as a screw connection. After disconnecting the releasable connection at the low-voltage side, the driver may then be arranged to be moved in a direction from the low-voltage side towards the high-voltage side so that the driver (partly) slides into the junction box, thereby creating space at the low-voltage side to allow the driver to be tilted away from the back plate.

The back plate may have one or more lips for clamping to a side of the driver, when the driver is connected to the back plate.

The back plate may have a first lip that is located approximately at a center of the opening, wherein the first lip is oriented at an acute angle relative to the back plate, thereby providing a space for allowing a user to grasp the driver when the driver is arranged in the opening of the back plate.

The back plate may have a second lip that is located adjacent to the first lip, wherein the second lip is oriented at a substantially right angle relative to the back plate, thereby providing a surface for clamping a side of the driver when the driver is arranged in the opening of the back plate.

The luminaire may further comprise a front rim constituting a front side of the luminaire housing.

The advent of LED technology has opened new avenues from an optical perspective, directing the light to where it is needed. Although this brings great possibilities when it comes to application efficiency, it also warrants care to find the right balance between visual comfort and performance.

The luminaire according to the invention takes this one step further, adding a high degree of flexibility, so that it can support both a range of designs and applications and the diverse needs of building occupants and their activities.

The luminaire is designed so that it can be used in common spacings such as in a range of 240 to 300 centimeters on center (OC), but it can also support spacings of up to 425 centimeters OC. This improves cost-effectiveness while providing IES RP-10 compliant uniformity and a UGR 19 specification (according to the more stringent CIE 232 requirements), delivering performance above and beyond existing solutions on the market, strengthened by the insight that both uniformity and glare reduction are important areas to address for neuro-diverse and visually impaired end users.

The luminaire addresses the optical design challenge formed by the contradicting targets of large luminaire spacings and high uniformity (requiring a wide beam and a high flux) while simultaneously minimizing glare to meet the UGR target, which is generally impacted negatively by the spacing and uniformity targets.

The luminaire is designed to result in an efficient optical system, from both a luminous efficacy and application efficiency perspective.

The luminaire provides an optical solution with a clearly defined lighting distribution geared towards high uniformity, large spacings and low UGR. The total solution minimizes losses by limiting interactions and absorption of light, while maximizing the light emitting area and simultaneously limiting the luminous flux above 65 degrees (from nadir).

Within this context, several uniformity measure options can be pursued. IES-RP-10-20 prescribes the maximum-to-average ratio, but the maximum-to-minimum (Max:Min) ratio and the average-to-minimum (Avg:Min) ratio are also widely used in practice (with the same 2:1 limiting value). When maximum project coverage is the target of luminaire design, the most stringent choice would be the Max:Min requirement.

Under such boundary conditions and based on numeric targets and ensuring sufficient overlap between beams to avoid patches of light, a rough theoretical distribution can be determined, from which the inventors realized that traditional diffuser/lens plates would not suffice.

Instead, individual, custom, free-shape lenses, such as the lenses, can be designed to provide a “base′” lighting distribution. In addition, to maximize the light emitting area, clusters of four LEDs and lenses can be placed in relatively shallow cups, optimized for visual appearance while providing cut-offs under regular viewing angles for typical gaze directions in working conditions.

The lenses can be designed to illuminate the walls of the cups and enlarge the illuminated area, specifically to meet the requirements of CIE 232, which indicates a minimum luminance of 500 cd/m² to be considered as light emitting surface.

To limit losses by the walls of the cups, one may choose to not go beyond a luminance of 500 cd/m² to maintain a relatively high luminous efficacy (expressed in lm/W). The combination of lens and cup may provide a lighting distribution that can be classified as UGR≤19, meeting the requirement for 94% of the values in the UGR table and all uniformity requirements.

An improved beam shape may bring a substantial improvement in application efficiency compared to Lambertian distributions. As the practical efficiency gain depends on the spacing used, differences for large, open plan offices using different luminaire spacings can be calculated.

Table 1 compares the distribution of the luminaire according to the invention to a prior art 60-by-60 centimeters luminaire with a Lambertian distribution. As can be seen in Table 1, up to a 4% improvement can be realized when comparing the same spacings for the two different distribution types. Starting from a 195 lm/W baseline, an additional 4% would result in an efficacy equivalent to creating a 203 lm/W fixture.

The comparison of Table 1 is an “unconstrained” comparison and simply investigates the efficiency of a beam to deliver task illuminance regardless of other requirements such as UGR and spacing. However, a 60-by-60 centimeters luminaire with a Lambertian distribution will never reach the required spacing given the UGR, uniformity and task level requirements. In practice, even larger application efficiency gains can be realized when considering some of these constraints. For example, the Lambertian distribution can only be used for OC spacings of up to 300 centimeters (after which the uniformity constraint is violated), whereas the luminaire according to the present invention can reach up to 425 centimeters spacing. When comparing the data of the luminaire for a 425 centimeters OC spacing (with a distribution efficiency of 26.40) with those of a Lambertian distribution at 300 centimeters OC spacing, the additional energy savings is about 6% (equivalent to a luminaire of 207 lm/W).

The data in Table 1 was calculated using the boundary conditions mentioned below.

For each OC spacing, the room dimensions were adjusted to have a distance of half the spacing between the wall and the first luminaire. This was done to provide a fair comparison between different spacings and avoid favoring setups with luminaires closer to the wall, which would result in better uniformity (through a higher minimum value) and/or higher average luminance values.

The outside row of grid points was removed to simulate actual work zones (and prevent over-sensitivity to calculation points close to the wall).

The space height was assumed to be 275 centimeters.

The Light Loss Factor for this comparison was set to 1 for both cases (as this is simply a distribution comparison).

Due to the differences in room dimensions and numbers of fixtures, efficiency was calculated as the total flux needed to illuminate a surface of 1 square meter with an illuminance of 300 lux, normalized to the space surface area.

The luminaire according to the present invention delivers a novel optic that can flex to check all boxes, from application efficiency and efficacy to visual comfort and quality of light.

TABLE 1
Comparison of a luminaire according to the invention and
a prior art luminaire with a Lambertian distribution.
Luminaire according to the invention

| | | Room | Uniformity | Distribution |
|---|---|---|---|---|
| OC spacing | Number of | dimension | ratio | efficiency |
| [cm] | luminaires | [m] | [Max:Min] | [*] |
| 240 × 240 | 64 (8 × 8) | 20 × 20 | 1.71 | 28.09 |
| 300 × 300 | 36 (6 × 6) | 18 × 18 | 1.50 | 27.30 |
| 365 × 365 | 25 (5 × 5) | 18 × 18 | 1.40 | 26.92 |
| 425 × 425 | 16 (4 × 4) | 17 × 17 | 2.00 | 26.40 |

State of the art luminaire with a Lambertian distribution

| | | Room | | Distribution |
|---|---|---|---|---|
| OC spacing | Number of | dimension | Uniformity | efficiency |
| [cm] | luminaires | [m] | [Max:Min] | [*] |
| 240 × 240 | 64 (8 × 8) | 20 × 20 | 1.41 | 28.84 |
| 300 × 300 | 36 (6 × 6) | 18 × 18 | 1.74 | 27.98 |
| 365 × 365 | 25 (5 × 5) | 18 × 18 | 2.15 | 27.62 |
| 425 × 425 | 16 (4 × 4) | 17 × 17 | 3.25 | 27.47 |

[*] The distribution efficiency is a measure for the total flux needed, from a given luminaire, to illuminate a surface of 1 square meter with an illuminance of 300 lux.

A recurring problem in the commercial building industry is the so-called “split incentive dilemma”, where the incentive to innovate only benefits one area but no other parts of the value chain. This can be a blocker to energy efficiency and other innovations.

For example, a building owner may be asked to adopt energy-efficient solutions, but to offset the cost of this innovation (not even to gain additional profit), the rental prices have to be increased. For the user of the space, this increase in rental cost implies that any financial benefits of the installation will be zero in the foreseeable future. As this entire process is invasive, time consuming and potentially requires renegotiation of contracts, the benefits to either party are often seen as too low, and the barrier to investing too high.

The luminaire according to the invention helps to overcome this dilemma. The luminaire is not just a single, “peak design” luminaire. Instead, it has been designed to benefit (almost) all parts of the value chain, from specification to installation, and all stakeholders, from the building owner to the user.

The luminaire represents a next-generation modular solution that creates a “shared incentive” value proposition (light without compromise).

The luminaire uses a state-of-the-art optic, which spreads the light wider than most solutions on the market and, by doing so, reduces the number of luminaires needed in a space.

Standard troffers (of either 60-by-60 centimeters or 60-by-120 centimeters) have a Lambertian/diffuse lighting distribution and are typically used in a 300-by-300 centimeters on center (OC) spacing configuration to meet task illuminance and uniformity requirements. In this case, one would need about one luminaire per 9 square meters. The present invention allows an extension to about one luminaire per 18 square meters, achieving a reduction of about 50% in the number of luminaires needed.

Compared to an OC spacing of 365-by-365 centimeters (which is common for more advanced luminaires), the luminaire of the present invention would still yield a reduction of about 25% in the number of luminaires needed. This will support a more affordable, initial investment as well as an easier and faster installation experience for the installer, helping to create a shared incentive.

Similar to Table 1, Table 2 compares the distribution of the luminaire according to the invention to a prior art luminaires with a Lambertian distribution.

TABLE 2
Comparison of a luminaire according to the invention and
a prior art luminaire with a Lambertian distribution.

| OC | | Room | Number of | | | | | | |
|---|---|---|---|---|---|---|---|---|---|
| spacing | Number of | dimension | modules per | Illuminance [lux] | | | Uniformity ratio | | |
| [cm] | luminaires | [m] | luminaire | Avg. | Max. | Min. | Avg:Min | Max:Min | Max:Avg |

Luminaire according to the invention

| | | | | | | | | | |
|---|---|---|---|---|---|---|---|---|---|
| 240 × 240 | 64 (8 × 8) | 20 × 20 | 3 | 390 | 431 | 252 | 1.55 | 1.71 | 1.10 |
| 300 × 300 | 36 (6 × 6) | 18 × 18 | 4 | 341 | 377 | 252 | 1.35 | 1.50 | 1.10 |
| 365 × 365 | 25 (5 × 5) | 18 × 18 | 6 | 361 | 406 | 290 | 1.25 | 1.40 | 1.13 |
| 425 × 425 | 16 (4 × 4) | 17 × 17 | 8 | 358 | 490 | 245 | 1.46 | 2.00 | 1.37 |

Prior art luminaire with a Lambertian distribution

| | | | | | | | | | |
|---|---|---|---|---|---|---|---|---|---|
| 240 × 240 | 64 (8 × 8) | 20 × 20 | — | 516 | 593 | 420 | 1.23 | 1.41 | 1.15 |
| 300 × 300 | 36 (6 × 6) | 18 × 18 | — | 340 | 462 | 266 | 1.28 | 1.74 | 1.36 |
| 365 × 365 | 25 (5 × 5) | 18 × 18 | — | 239 | 358 | 167 | 1.43 | 2.15 | 1.50 |
| 425 × 425 | 16 (4 × 4) | 17 × 17 | — | 177 | 347 | 107 | 1.66 | 3.25 | 1.96 |

The luminaire according to the invention allows a flexible approach that also supports cost-effectiveness across the full value chain. In contrast to a luminaire with one specific function, a modular platform approach, using a varying number of lighting modules with different functions in different housing types, enables certain features and benefits, some of which will be explained below.

A first feature and benefit is that, during the design phase, luminaires can be configured to fit current and future needs and combine different lighting functions into a single housing, such as general lighting, accent lighting or wall washing. Again, it means less luminaires are needed for installation, and they can be easily modified according to the user's requirements.

A second feature and benefit is that lighting designs can be more carefully balanced to support neuro-diverse and visually impaired individuals as the amount of light (and the future direction of light) from each luminaire in the grid can be modified to generate the exact right balance in their visual field.

A third feature and benefit is that modules, such as lighting modules, can be reused elsewhere, be it in the same or different luminaire types (e.g., troffers, suspended lines, or surface-mounted solutions). Having a LED board that is compliant to the LED set power interface of Zhaga Book 22, which guarantees a constant lumen output per lighting module without reprogramming the driver, regardless of the number of lighting modules, makes the lighting modules “plug and play” without driver configuration, thereby further adding to the cost-effectiveness.

A fourth feature and benefit is that repair of luminaires can be done in situ without having to remove them. The lighting modules and the driver are accessible from the room/bottom without special tools and can be easily swapped out with another module (which is small and less expensive to keep in stock). Driver repair is simple by using a class II driver.

A fifth feature and benefit is that building projects, where the tenant is not yet known, can start with a base level of lighting installed using fewer modules to keep costs down. Once a tenant and its space allocation are known, the lighting can be easily “upgraded” to meet its needs. This allows for a tailored approach while preventing waste, as fixtures can be upgraded instead of replaced.

A sixth feature and benefit is that when a space is assigned a new function, the luminaire configuration (the number and type of modules) can be easily adjusted to fit the new function instead of having to take out and replace the luminaires, again reducing installation and material costs.

A seventh feature and benefit is that the replaceability of the lighting modules allows for so-called “Lighting as a Service” (LAAS) propositions as they are easy to maintain.

For the purpose of customization and flexibility, alternative optical components may be designed to support specific needs of the end user or customer.

A first example of such an alternative optical component is a cone-shaped distributor that, instead of a lens system, may be combined with a reflective cup. This example would enlarge the light-emitting surface even further. It delivers lower contrast, which is ideal for a neurodiverse population, photosensitive individuals, or elderly, who are more likely to suffer from glare.

A second example of such an alternative optical component is a wall-washing optic, using a similar cup design (for a consistent look and feel), but a different lens to focus the light from the lighting module that employs the component onto a wall, to provide even illumination should this be desired.

Central to the design of the luminaire according to the invention is a lighting module, which can fit in different housing form factors and/or luminaire (fixture) types. The width and length of the lighting module has been determined based on two targets: (i) the ability to support common troffer formats (such as 60-by-60 centimeters and 60-by-120 centimeters), and (ii) the ability to create lines of light.

A troffer format refers to a lighting archetype that is historically the most common luminaire used in offices, in addition to schools and government buildings. To improve occupant experience, there is a desire to innovate and rejuvenate the troffer format.

The luminaire according to the invention is designed so that it can be applied as a 60-by-60 centimeters recessed luminaire. However, different troffer sizes with a different number of lighting modules, suspended, surface mounted or recessed linear, and many other luminaire configurations are possible with this design.

With regard to the size of the lighting module, the surface area of the 60-by-60 centimeters and 60-by-120 centimeters troffers preferably fit an integral number of these lighting modules (and optionally also a sensor) with reasonable luminous flux steps and without an excessive number of modules. To create lines of light, the width of a single lighting module needs to be limited, which implies a width between about 5 and 10 centimeters. An optimal lighting module size may have a width of about 8.5 centimeters, a length of about 57 centimeters and a luminous flux of about 780 lm (kept constant over life).

By utilizing such lighting modules in a housing (rather, a mechanical holder that is easy to redesign), a variety of luminaire types can be created. This may be further enabled by using a high efficiency driver, developed specifically for the lighting modules, which can power between two and eight lighting modules, without requiring any modification or reconfiguration. Additionally, having the mounting mechanism be part of the lighting module, and only requiring a few relatively small slots in the back plate to work, makes any redesign of the housing even easier.

3D printing can be leveraged to simplify the housing design for suspended and surface mounted luminaires. This technique eliminates additional costly tooling requirements, can lead to an even larger variety of potential form factors and designs, and minimizes inventory requirements, allowing for that variety of form factors without large production volumes (which are normally needed to offset/justify tooling costs). With 3D printing, only digital files need to be “stored” as “spare parts”.

Finally, having lighting modules that are agnostic to the housing type ensures that the variety in form factors does not result in a more complex ecosystem during the design, installation, and maintenance phases of a project, improving the chances of successful market adoption of this concept.

The luminaire according to the invention allows for a customization of the appearance of the optical components. For example, the reflective cups may have different designs. The perimeter of the opening of the reflective cups may have a leaf shape, a polygonal shape, a circular shape, an elliptical shape, an ovate shape, a teardrop shape, or any other shape. This would transform the light exit window of the luminaire from a “standard”, geometric appearance to a light texture, where designers can choose from a number of different styles to match their design intent. This also creates customization opportunities for recessed luminaires, which traditionally have limited aesthetic variation, and for face trim plates having a textured appearance.

The luminaire according to the invention allows traditional form factors to be created (for example, troffers, suspended and surface-mounted luminaires), as well as several other directions designers could pursue, for example more free-form shapes, such as open structures.

To define the major sustainable innovation directions towards circular luminaires, available environmental impact analyses of lighting products were consulted. This showed that out of the different life cycle stages, the contribution to global warming potential (GWP) is determined by the use phase (up to 95%). The dominant contribution of the use phase is attributable to the energy consumption of the lighting installation during application lifetime.

Secondly, in the long term, increasing the utilization period will result in a decreasing demand for resources to build new luminaires. Hence, innovations that increase and predict the luminaire lifetime in the application or empower repurpose/remanufacturing strategies by circular modular design will be beneficial in reducing the environmental impact of artificial lighting solutions over time.

Accordingly, an architecture optimized for a low energy consumption and a long lifetime was designed and prototyped. With the aim of delivering also on the most environmental-friendly luminaire and lighting design solution, a deep dive in the required amount and type of materials, the labelling of the materials as well as the production/manufacturing methods was executed.

Finally, attention has been paid to extending the life cycle by defining modules by circular design thinking empowering the different loops as defined in, for instance, the 9R model as described by Julian Kirchherr et al. in “Conceptualizing the circular economy: An analysis of 114 definitions” (Resources, Conservation and Recycling, Volume 127, December 2017, pages 221-232).

As a result, the materials and sustainability innovations applied in the luminaire according to the invention allow a significant improvement in both the carbon emissions during the use phase as well as the embodied carbon used in the luminaire itself: (i) 35% reduction in energy consumption and more than a factor two lifetime improvement, (ii) 30% reduction in the number of luminaires per square feet, (iii) 57% reduction in embodied carbon (GWP per functional unit being 1000 lumen per 35,000 hours), and (iv) a reversible click-and-clamp architecture to empower the life cycle extension of the luminaire, modules and components (housing, modules and materials).

Underpinned by a life cycle assessment deep dive, a first focus in the design of the luminaire according to the invention was ensuring a substantial luminaire efficacy gain, without considering any hard cost constraints like linear economy innovations are often all about. To fulfill the luminaire efficacy gain, directing the light where it is needed is most desirable. Therefore, the design of the luminaire according to the invention is that of a troffer luminaire with an optical beam, instead of the design of a panel luminaire. Compared to the mean efficacy of known troffer luminaires (with a CRI of more than 90), which is about 120 lm/W, the luminaire according to the invention gives an efficacy gain of about 60%, corresponding to more than 190 lm/W.

Contributing to the total efficacy improvement are improvements in LED efficiency, LED current reduction, optical efficiency, driver efficiency, and application efficiency.

The luminaire according to the invention allows the use of flip chip technology. By means of spectral modelling, the inventors have defined the most energy efficient spectrum while still achieving desired color quality requirements. The spectral modelling led to the development of a special LED with a dedicated phosphor composition, that combines extremely good color rendering (R9>90, CRI 95) with a very high efficacy of about 205 lm/W (on LED level at standard operating conditions), which is about 19% more than what can be achieved with commercially available LEDs having the same color quality.

By increasing the number of LEDs, the current through each individual LED may be reduced, which in turn may enable efficiency optimized operation (e.g., through minimizing the droop effect, which refers to a phenomenon where LED efficiency drops off significantly under the application of relatively high currents). In total, less electrical power is required to create the desired lumen output of the luminaire.

For minimizing the energy consumption during the use phase, the number of LEDs per luminaire may be optimized for energy efficacy. The luminaire according to the invention allows an additional 13% to be achieved, leading to ultra-high efficacy of more than 228 lm/W on LED level. At the same time, the lower current decreases stresses within the LED, which will also prolong the lifetime of the LED board. So, by reducing the current, the luminaire according to the invention enables an improvement in efficiency, and also allows a reduction in stress and temperature, leading to a longer life time.

Driver optimizations may be applied by rethinking the electrolyte capacitors, using best-in-class flyback, an optimized low-loss transformer, linear regulator with advanced head room control, and active rectifier. Through these optimizations, the luminaire according to the invention may be equipped with a driver that reduces the LED current ripple and outperforms commonly applied dual-stage LED drivers with respect to driver losses. As a result, driver loss may be reduced by nearly 20% compared with known LED drivers, and driver efficacy gains of about 9% may be achieved.

The luminaire according to the invention may also benefit from further developments on the materials used in the optical path. For example, bio-based optical materials with a relatively high transparency of more than 92% may be used for the lenses. Bio-based polycarbonate may be used for the cups, wherein titanium oxide may be added to the bio-based polycarbonate to provide a sufficiently high cup reflectivity. By a combination of optical material choices and optical design, an optical efficiency gain of about 16% may be achieved. A further reduction in energy consumption during the use phase may be possible by means of clever optical design towards real applications. Compared to known luminaires, the luminaire according to the invention enables an increase of about 40% in luminaire spacing in the actual application, from about 3 meters (corresponding to 10 feet) to more than 4 meters (corresponding to 14 feet). Such an increase in spacing may lead to a potential additional energy savings of about 6% (equivalent to a luminaire of about 200 lm/W). Focusing on a substantial luminaire efficacy gain may be accompanied by the use of more materials, which would go at the expense of the perceived “green” character of a luminaire. Adhering to the circular economy philosophy of being careful in using resources at the design phase and generating waste at end of life, rethinking design and less intensive manufacturing choices may be explored to come to a luminaire that combines ultra efficiency and long lifetime with a significant improvement in the use of resources and hazardous waste.

One may apply a comparable systematic approach of considering design issues related with the human health and environment over the product life cycle, for example as outlined by Rayate in “A tool for selection of design for manufacturing and assembly rules during product design stage while considering end of life conditions” (Thesis, Clemson University, 2012).

The resulting product design is considerate in the use of resources, cares to minimize waste to landfill, eliminates as much as possible (hazardous) waste in manufacturing processes, reducing carbon emissions for transport and avoids the use of paint and surface treatments if not absolutely needed.

One may estimate the impact of material choices for global warming potential (GWP) for each of the following material categories: electronics, metals, plastics, and others. The GWP may be used as a measure for the carbon footprint of a luminaire.

Compared to a benchmark analysis of widely applied US troffer luminaires, the luminaire according to the invention allows a GWP that is about 15 to 30% lower. Such GWP reduction may come from using aluminum instead of steel for the housing, and/or from using bio-based plastics for the optics and/or for the cover.

The luminaire according to the invention further allows for about 30% less luminaires per square feet, which may effectively decrease the GWP contribution of the driver with about 30% as compared to a configuration with standard luminaires.

For real-impact-comparison, the GWP may be normalized with a functional unit of 1000 lumen at 35,000 hours. The combination of material choice, lumen output, and lifetime may result in a 64% reduction in the normalized GWP when comparing the luminaire according to the invention with the mean of a benchmark of popular US troffers.

An obvious route for innovations in reducing material resources for a light design, is to reduce the number of luminaires to provide for the required illumination on a desk. A commonly applied spacing of between 2 to 3 meters is a consequence of the lumen bundles of commercially available luminaires of 3,000 lumen where the lumen output is constrained by glare and uniformity requirements. A technological challenge encountered in the desire to reduce the number of luminaires is hence controlling glare and uniformity at higher lumen outputs.

The luminaire according to the invention is arranged to provide 4,800 lumen, with good glare and uniformity ratings, through a combination of the number of LEDs and the optical design. The result is a reduction in the number of luminaires, and hence their components, of about 30%. An additional benefit of increasing the spacing between luminaires is a reduction in electric cables during installation. As such, a spacing of more than 4 meters contributes to an improvement in carbon footprint during the manufacturing and use phases and generates less electronic waste at end-of-life.

The optical design of the luminaire according to the invention allows for a smaller optical cup, in turn leading to a relatively shallow luminaire design of about 20 mm. The luminaire according to the invention may further have a total weight of about 3 kg. Furthermore, the weight per square meter is considerably reduced due to the larger spacing. Further material reduction may be achieved by letting the driver be a part of the luminaire housing (as required by UL standard 1598). The driver housing for electric enclosure may be minimized by only applying the housing locally near the main terminal. In addition to the lower carbon footprint of the luminaire according to the invention, the reduced volume and weight also translates into reduced carbon emissions during transport.

For the luminaire according to the invention, selection of the materials may be based upon an environmental impact evaluation and quality assessment in relation to office illumination requirements. Special attention may be paid to whether specification sheets of material candidates refer to compliance with certain regulations, such as those on the registration, evaluation, authorization, and restriction of chemicals (REACH) and/or on occupational safety and health (OSH).

For the luminaire according to the invention, in case the housing would not be visible, non-painted aluminum (82% recycled content) may be used instead of paint-steel. The use of aluminum is more environmentally friendly and has a better recyclability at end-of-life.

Further, bio-based plastics may be used for the lenses and reflector cups, including mechanical connectors, such as Makrolon RW2407 and RW2407-RE, with 57% and 48% bio content, respectively.

Also, the plastic coating of the wires used in the luminaire may comprise PVC and be free of halogens. Due to the improved efficacy, lower currents are running through the cables allowing for a thickness reduction. For example, AWG22 may be used locally, while the main cable tree may be AWG20, compared to a common practice cable dimension of AWG18.

The components of the luminaire according to the invention may be labelled to facilitate end-of-life recycling. The luminaire according to the invention may be delivered with a QR code providing the required material transparency and easy ordering of new components for repair or upgrade purposes.

The manufacturing process of PCBs required for L2 boards is known as an environmentally unfriendly production method. The luminaire according to invention allows the use of an additive manufacturing technology (such as printed electronics) to eliminate the most hazardous processing step, electrochemical etching, a process involving strong acids/alkali known to pollute (drinking) water. A transition from conventional to printed electronics may significantly reduce freshwater usage. Additive manufacturing, like printed electronics, may reduce the global warming potential (GWP) and abiotic resource depletion (ADP) with 50% with constant substrate, or even up to 86% when moving to more environmentally friendly substrates. This is considerable, considering that the electricity required for conventional PCB contributes 41% and 38% to the GWP and ADP, respectively. Besides a lower environmental impact during manufacturing, printed electronics also allow for local-to-local production.

For the luminaire according to the invention, aluminum substrates may be chosen. Aluminum offers the rigidity of the LED board required for (re)-assembly. A pressure sensitive adhesive (PSA) may be used to fix the printed electronics on the aluminum substrate. A PSA is in principle a reversible glue that softens and releases when heated. As such, a PSA is a recycle-friendly glue.

Apart from using printed electronics as manufacturing technique for the PCBs of the luminaire according to the invention, the latter may have a design that leads to lowest resistive losses, given a fixed (max) amount of silver paste. This is achieved by optimizing the design to be processable as a single layer PCB without crossovers.

The packaging of the luminaire according to the invention may comprise recycled paper, such as 80% recycled paper-based packaging. The design of the luminaire according to the invention is such that the packaging volume can be minimized, allowing for more efficient transport. Recycling of cardboard packaging material may be chosen above returning the packaging back to the manufacturing sites, which prevents undesirable carbon dioxide emissions of transport. At end of life, more than 70% of the packaging may be recycled or composted.

Environmental care may also be considered for the installation and specification guides, which are usually delivered on paper in multiple languages. Instead, one may choose a QR code through a special developed service tag, which enables multiple categories to store documents via QR code: (i) image of the product (JPEG format, less than 5 MB), (ii) mounting instructions document (PDF format, less than 5 MB), (iii) user manual, (iv) service manual, (v) troubleshooting guide, and (vi) photometric data. The service tag may also be designed to include the material hazardous substance data of the components, life cycle assessments and product passport, which would allow for the correct choice for recycling.

Modularity is key in retaining the highest value of a product as long as possible. The luminaire according to the present invention represents a breakthrough architecture that simultaneously extends the use phase, by enabling repair, upgrade, re-assembly and repurpose, and facilitates recycle and recovery processes. The luminaire according to the invention has a configuration that allows a reversible “click-and-clamp” assembly. Such assembly makes screws and glue obsolete, and it endorses dis- and re-assembly. In principle, the configuration enables endless reuse of the housing, modules and or components.

The lighting modules of the luminaire according to the invention may be Zhaga-standardized and may be operated individually, which opens up the opportunity to use the lighting modules in different housing styles or to combine a different number of modules. Therefore, their reuse potential is larger than those of traditional luminaires, which are typically single archetype, single output. The use of standardized lighting modules also reduces the stock need and will improve manufacturing efficiency as only one module type has to be made to provide for multiple housing archetypes. Moreover, the luminaire according to the invention is designed such that the driver can be accessed on opposite sides of the luminaire, to facilitate installation as well as room-side repair.

The housing components of the luminaire according to the invention may be manufactured by means of injection molding technologies, but they may also be manufactured by means of 3D printing technologies, which will facilitate on demand component delivery, also after an economical lifetime (repair on demand) if desired.

A transition of a linear economy to a circular economy does not only depend on a circular architecture. In the end, circular business models are key in achieving the ambitions to retaining the highest value of a product. Together with their customers, manufacturers of luminaires may actively discuss and offer performance contracts, end-of-life contracts and even take back programs.

In the luminaire according to the invention, the positioning of the driver is such that it simplifies assembly and maintenance. Placing a driver housing with a sliding mechanism at the back of the luminaire at the side of the sensor slot allows the creation of a double-sided service system. During installation, such a sliding mechanism would be accessible from the back to connect the electric wires. But when installed in a ceiling, the luminaire according to the invention can also be repaired from the room-side. The lighting module near the sensor slot can be removed via a mechanical lip, and via releasing the spring that connects the lighting module to the back plate. Subsequently, the driver can be taken out of the luminaire; without demounting the entire luminaire. The luminaire according to the invention allows a removal of the driver in about 20 seconds, which significantly alleviates the burden of repair.

A stable lighting installation with a lifetime of at least 100,000 hours may be enabled by ensuring constant lumen output to compensate for a natural decrease in light output of the LED board over time. A constant lumen output may be enabled by the driver. The driver may store the operating hours of a lighting module, power a LED below its maximum rated lumen output, then increase the output current over time in response to a natural reduction in lumen output over the lifetime of the fitting.

A LED board that is compliant to the LEDset power interface of Zhaga Book 22 guarantees a constant lumen output per lighting module without reprogramming the driver, regardless of the number of lighting modules. The constant lumen output does not only facilitate long application lifetime but also brings an additional dimension to ease-of-installation for in-between renovations, upgrading or reuse. The individual lighting modules themselves, if sufficient lifetime remains, can be easily redeployed in other housings at, for instance, a different floor in a building, or in other buildings or projects.

The driver may be equipped with a service tag that provides for remaining useful lifetime information. For example, it may provide the actual burning hours of the luminaire, the number of on-off cycles of the driver, and the thermal history of the driver. Read out of the service tag can be done per luminaire via near field communication (NFC), via an app, or remotely via a cloud-based server. The obtained information on remaining useful lifetime is useful during recycling and/or refurbishment, when a luminaire would no longer be connected to a system. It also enables users that did not opt for a fully connected system to get data on the lifetime status. It allows for preventive or just in time maintenance. When connected to a cloud-based system architecture, remote trouble shooting to identify failing components is possible. Further, it contains component information and brings peace of mind when ordering components for the purpose of repair.

The luminaire according to the invention may be equipped with a reversible click-and-clamp architecture. Such architecture enables a sustainable luminaire and drives the change to a circular economy forward. A reversible click-and-clamp architecture makes screws and glue obsolete, endorses dis- and re-assembly and is envisioned to foster endless reuse of the housing, modules and or components.

The luminaire according to the invention may have one or more lighting modules that are Zhaga complaint and formed out of two base substrates (or LED boards), an array of lenses and a cup plate. The lighting module may have fixations points to align and fixate components in the xy plane. For example, recesses or grooves may be provided in the cup plate for alignment of the lens array in the xy plane. Furthermore, protrusions or pillars may be provided in the cup plate for fixing and aligning the base substrates (LED boards) with respect to the lens array. The position of such protrusions or pillars may be based on Zhaga book 7, which defines a family of linear and square LED modules that typically could be used for indoor lighting applications. Alignment in the z-direction may be achieved by optimizing and shaping the LED board such as to mate with the backplate.

For the luminaire according to the invention, assembly is ensured by the dimple structure in the back plate, which provides for mechanical alignment. The dimple structure has one or more rows of dimples for which each row is shared by two lighting modules. By mounting a lighting module using the bistable spring feature, the components are fixated, centered, and held together, ensuring good thermal contact and optical alignment, and preventing any light leakage. The dimple structure may also act as thermal connection. In other words, by means of careful application of materials, such as the use of aluminum for the backplate (and optionally also further parts of the housing), the latter not only functions as housing (or housing component) but also as a thermal connector and for mechanical alignment.

In the luminaire according to the invention, the mechanical features for lighting module assembly ensure a quick lighting module disassembly process, since screws, glue or any other type of irreversible connections are avoided. The disassembly process, optionally in combination with labeled components existing of a single material, will facilitate re-assembly or recycling and recovery processes at end-of-life.

As such, mechanical, software, and labelling features may provide for a circular architecture that can extend (i) the use phase of the luminaire by enabling repair, upgrade, (ii) the use of individual lighting modules by re-assembly and repurpose, and (iii) the use of materials by facilitating recycling and recovery processes. This in turn enables retaining the highest value of a product, while extending the life cycle of the housing, lighting modules, and materials, being the aim of the circular economy philosophy.

The materials and sustainable innovations applied in the luminaire according to the invention provide for a luminaire with an ultra-high efficacy, a reduced embodied carbon, and an extended life cycle, for example through a reversible click-and-clamp assembly architecture.

The luminaire according to the invention helps the transition from a linear economy to a circular economy, while simultaneously contributing to the carbon emissions reduction targets as stipulated in the Paris 2030 agreement. Raw materials, components and products are being able to be kept in circulation as long as possible. The luminaire according to the invention explores a route by rethinking the luminaire architecture and manufacturing as well as rethinking the traditional light design.

The luminaire according to the invention allows a significant improvement in both the carbon emissions during the use phase as well as the embodied carbon in the light design, while increasing the utilization lifetime of the luminaire, components, and materials. It allows a 35% reduction in energy consumption and a factor two lifetime improvement. It allows a 30% reduction in the number of luminaires per square meter. It allows a 57% (mean) reduction in embodied carbon by out-designed materials, best material choice within specifications, and applied “cleaner” manufacturing techniques. It allows a reversible click-and-clamp architecture to empower the life cycle extension of the luminaire, modules, and components (housing, modules, and materials).

Further objectives, features, and advantages of the invention will become apparent when studying the following detailed disclosure, the drawings, and the appended claims.

Those skilled in the art will realize that different features of the invention can be combined to create embodiments other than those described in the following.

### BRIEF DESCRIPTION OF THE DRAWINGS

Embodiments of the invention will now be described, by way of example only, with reference to the accompanying schematic drawings in which corresponding reference numerals indicate corresponding parts.

FIG. 1 is an exploded view of a luminaire.

FIG. 2 is a view of a back side of a luminaire.

FIG. 3 is a view of a cross section along axis A shown in FIG. 2.

FIG. 4 is a close-up of the view of FIG. 3.

FIG. 5 is a view of a cross section along axis B shown in FIG. 2.

FIG. 6 is a close-up of the view of FIG. 5.

FIG. 7 is a view of a luminaire in a closed configuration.

FIG. 8 is a view of a luminaire in a closed configuration.

FIG. 9 is a view of a luminaire in a service configuration.

FIG. 10 is a view of a luminaire in a service configuration.

FIG. 11 is a view of a luminaire in a service configuration.

FIG. 12 is a view of a luminaire in a service configuration.

FIG. 13 is a view of a luminaire in a service configuration.

FIG. 14 is a view of a luminaire.

FIG. 15 is a view of a luminaire.

FIG. 16 is a view of a back side of a luminaire.

FIG. 17 is a close-up of the view of FIG. 16.

FIG. 18 is a view of a back side of a luminaire.

FIG. 19 is a close-up of the view of FIG. 18.

FIG. 20 are perspective views of a spring.

FIG. 21 are front views of a spring.

FIG. 22 are side views of a spring.

FIG. 23 is a front view of a luminaire.

FIG. 24 is a close-up of the front view of FIG. 23.

FIG. 25 is a view of a back side of a luminaire in a closed configuration.

FIG. 26 is a view of a back side of a luminaire in a service configuration.

FIG. 27 is a view of a back side of a luminaire in a service configuration.

FIG. 28 is a close-up of the view of FIG. 27.

FIG. 29 is a close-up of a front side of a luminaire.

FIG. 30 is an exploded view of a lighting module in a non-assembled state.

FIG. 31 is an exploded view of a lighting module in a non-assembled state.

FIG. 32 is an exploded view of a lighting module in an assembled state.

FIG. 33 is a close-up of the view of FIG. 32.

FIG. 34 is an exploded view of a lighting module in an assembled state.

FIG. 35 are two perspective views of a lighting module.

FIG. 36 is a view from a back side of a lighting module.

FIG. 37 is a close-up of the view of FIG. 36.

FIG. 38 is a view from a front side of a lighting module.

FIG. 39 is a close-up of the view of FIG. 38.

FIG. 40 is a cross-sectional view of FIG. 39.

FIG. 41 is a cross-sectional view of FIG. 39.

FIG. 42 is a side view of a lighting module.

FIG. 43 is a side view of a lighting module.

FIG. 44 is a close-up of a lighting module.

FIG. 45 is a perspective view of a back side of a lighting module.

FIG. 46 is a close-up of the view of FIG. 45.

FIG. 47 is a view of components of a base substrate.

FIG. 48 is a view of a tool for assembling a lighting module.

FIG. 49 shows an alternative version of a back plate.

FIG. 50 is a perspective view of a 3D printed cup plate.

FIG. 51 is a perspective view of a 3D printed cup plate.

FIG. 52 shows tool paths for 3D printing a cup plate.

FIG. 53 is a perspective view of two luminaires packed back-to-back.

FIG. 54 is a close-up of the view of FIG. 52.

FIG. 55 is a side view of two luminaires packed back-to-back.

The schematic drawings are not necessarily to scale.

### DETAILED DESCRIPTION OF THE EMBODIMENTS

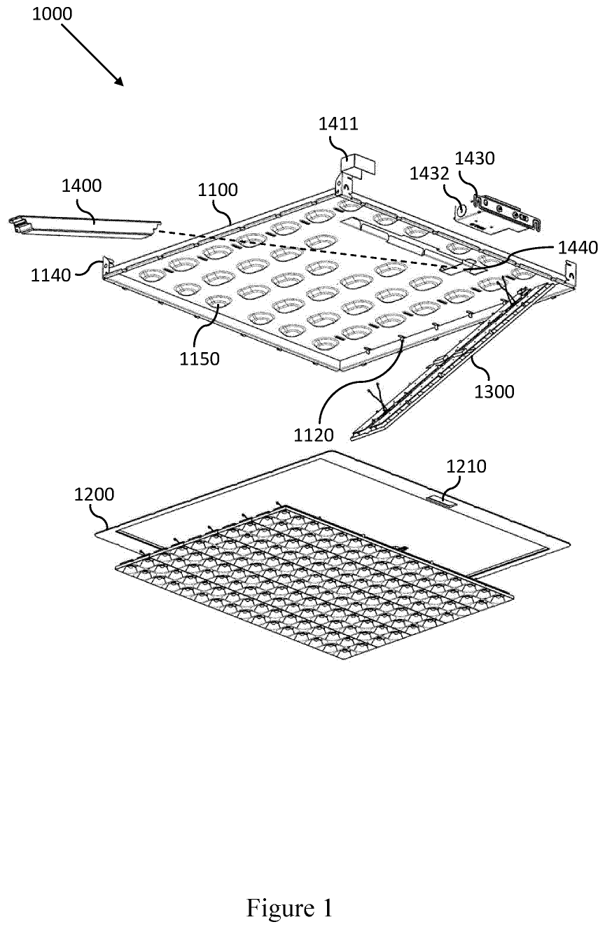

FIG. 1 is an exploded view of a luminaire 1000, showing some of its main components.

The luminaire 1000 has a back plate 1100, a front rim 1200, lighting modules 1300, and a driver 1400. The luminaire further has a cover 1411 for covering a low-voltage side of the driver 1400, a junction box 1430 having an entrance opening 1432 for receiving a wire carrying mains power.

The back plate 1100 constitutes a back side of a luminaire housing of the luminaire 1000, the front rim 1200 constituting a front side of the luminaire housing of the luminaire 1000. The lighting modules 1300 and the driver 1400 are arranged in the luminaire housing.

Parts of the back plate 1100 have been cut out and bent over to provide clips 1120 for guiding one or more electrical cables, such as an electrical cable for connecting a lighting module 1300 or a sensor to the driver 1400, along a side of the luminaire 1000.

The luminaire 1000 further has a sensor location 1210.

The sensor location 1210 is provided in the front rim 1200 of the luminaire 1000. The sensor location 1210 may be a sensor slot that complies with industry specifications as established by the Zhaga Consortium (such as a slot with a length of 60 mm and a width of 22 mm), or any other suitable sensor slot.

The back plate 1100 may have a break-out (or break-away) area at the sensor location 1210, to enable the accommodation of larger-size sensors.

The back plate 1100 is typically made from a metal. It has a front surface facing towards the lighting modules 1300 and an opposite back surface facing away from the lighting modules 1300.

The back plate 1100 has mounting means 1140 that may be used to mount the luminaire 1000 in a T-grid ceiling system. Such mounting means 1140 may be earthquake hooks, earthquake clips, earthquake clamps, seismic clips, or seismic clamps, that may be required to comply with certain national regulations for providing safety in case of an earthquake or any form of seismic activity.

The back plate 1100 further has a plurality of dimples 1150, being depressions or indentations in the back surface of the back plate 1100. Such dimples may also be referred to as dents.

The luminaire 1000 is designed such that a maximum of six lighting modules 1300 can be included. The invention is, however, not limited to any particular number of lighting modules, and the luminaire may easily be redesigned to accommodate up to any number of lighting modules.

In the luminaire 1000, the driver 1400 has a configuration that allows between two and eight lighting modules 1300 to be used without having to reconfigure the driver 1400. The invention is, however, not limited to any particular configuration of the driver.

Each lighting module 1300 has an elongated shape and comprises a plurality of lighting elements arranged in a 2-by-16 array. The invention is, however, not limited to any particular shape of the lighting module and arrangement of the lighting elements.

In the luminaire 1000, one of the lighting modules 1300 (being the only one that is indicated with a reference numeral) is shown in a so-called dangling position.

In the dangling position, one edge of the lighting module 1300 is connected to the back plate 1100 while an opposite edge of the lighting module 1300 is detached from the back plate 1100.

The fact that a lighting module 1300 can be in a dangling position enables easy assembly and disassembly of the luminaire 1000.

The driver 1400 can be assembled into the luminaire 1000 by means of an assembly bridge 1440 (see also the dashed line in FIG. 1). This enables easy assembly and disassembly.

The configuration of the luminaire 1400 enables a modular concept, or modular platform approach, that allows a user to select how many lighting modules to use in the luminaire. In such a modular concept, each lighting module 1300 as well as the driver 1400 can be considered a module.

A modular concept is advantageous from a sustainability perspective. A modular concept allows components to be reused everywhere in, for example, a building. It further makes repair and disassembly relatively easy. A modular concept can be used in different luminaires, and it motivates a user to only use the number of components or modules needed, and to repurpose elsewhere.

A modular concept supports cost-effectiveness across the full value chain. In contrast to a luminaire with one specific function, a modular concept, using a varying number of lighting modules with different functions in different housing types, enables one or more of several features and benefits, which will be further described below.

During the design phase, luminaires can be configured to fit current and future needs and combine different lighting functions into a single housing, such as general lighting, accent lighting or wall washing. This means that less luminaires may be needed for installation, and they can be easily modified according to the user's requirements.

Modules can be reused elsewhere, be it in the same or different luminaire types (such as troffers, suspended luminaires, or surface-mounted luminaires). A feature that makes the lighting modules “plug and play” without driver configuration further adds to the cost-effectiveness.

A modular concept allows the luminaires to be repaired in situ without having to remove them. The lighting modules and the driver are accessible without any special tools, and they can be easily exchanged with another module, which may be relatively small and less expensive to keep in stock. Driver repair is simple by using a class II driver.

Building projects, where the tenant is not yet known, can start with a base level of lighting installed using fewer modules to keep costs down. Once a tenant and its space allocation are known, the lighting can be easily “upgraded” to meet its needs. This allows for a tailored approach while preventing waste, as luminaires can be upgraded instead of replaced.

If a space is assigned a new function, the luminaire configuration (such as the number and type of modules) can be easily adjusted to fit the new function instead of having to take out and replace the luminaires, again reducing installation and material costs.

The replaceability of the modules also allows for so-called “Lighting as a Service” (LAAS) propositions, as they are easy to maintain.

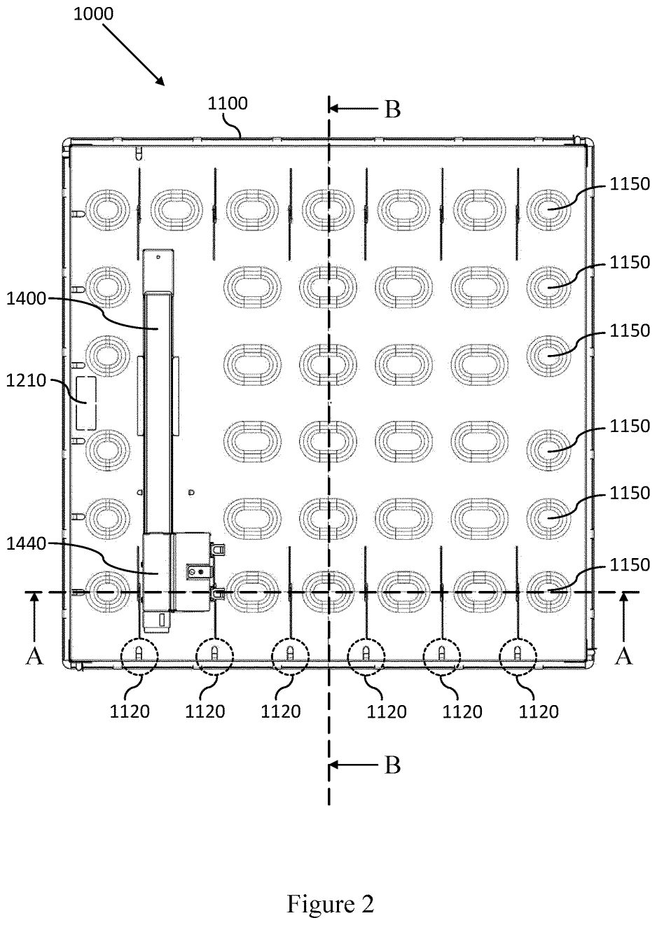

FIG. 2 is a view of a back side of a luminaire 1000.

The view of FIG. 2 shows a back surface of the back plate 1100. This is the surface that, in the luminaire 1000, faces away from the lighting modules 1300 (the latter are not visible in this view).

The back plate 1100 has a total of 37 dimples. Each such dimple (or dent) is a depression or indentations in the back surface of the back plate 1100.

The six dimples that are indicated with reference numeral 1150 in FIG. 2 are arranged in a linear array at one edge of the back plate 1100. These dimples 1150 all have a substantially circular base. A similar linear array of six dimples is visible at the opposite edge of the back plate 1100. The remaining 39 dimples have a substantially elliptical base.

The invention is, however, not limited to any particular number or arrangement of dimples, nor to dimples having any particular shape.

Also visible in the view of FIG. 2 is the driver 1400. The driver 1400 has a rectangular shape and it is located in a rectangular opening in the back plate 1100. The driver 1400 is kept in position by means of the assembly bridge 1440.

When connected to the back plate 1100, the driver 1400 provides a closure of the opening in the back plate 1100, to comply with standard UL1598, particularly to section 12.4 on requirements for recessed housings.

In other words, the opening provided in the back plate 1100 results in a partially open back side of the luminaire housing, whereby the presence of the driver 1400, when connected to the back plate 1100 and arranged in the opening, at least partly closes the opening. Hence, the driver 1400 provides or ensures a closure of the opening in the back plate 1100 when arranged therein, and consequently, a closure of the back side of the luminaire housing of the luminaire 1000. This has the advantage that the combination of the luminaire housing and the driver augment the fire resistance of the luminaire 1000. When the driver 1400 has a housing made from a metal, and when the back plate 1100 is also made from a metal, the fire resistance of the luminaire 1000 is even further improved.

The opening in the back plate 1100 is such that the driver 1400 can be easily replaced from a front surface of the back plate 1100, being a surface opposite to the back surface of the back plate 1100, without the need for any additional (removeable) cover element.

In line with the requirements of sections 5.3 to 5.5 of the aforementioned standard UL1598, the housing of the driver 1400 can be considered a substantial part of an enclosure of the luminaire 1000. Additional enclosure parts would only be needed locally around the mains voltage terminal of the driver 1400.

Also shown in the view of FIG. 2 are the clips 1120 for guiding one or more electrical cables along a side of the luminaire 1000. The clips 1120 are formed by parts of the back plate 1100 that have been cut out and bent over.

In FIG. 2, the clips 1120 indicated with a reference numeral are all located at the lower side of the back plate 1100. These clips 1120 can be used to guide the electrical cables from the lighting modules 1300 to the driver 1400.

Similar clips are located at the left side of the back plate 1100 (not indicated with reference numerals in the view of FIG. 2). These clips can be used to guide the electrical cable from a sensor that may be located at sensor location 1210 to the driver 1400.

The above configuration represents an innovative way of building an enclosure, which reduces the required amount of materials. This is advantageous from a sustainability point of view.

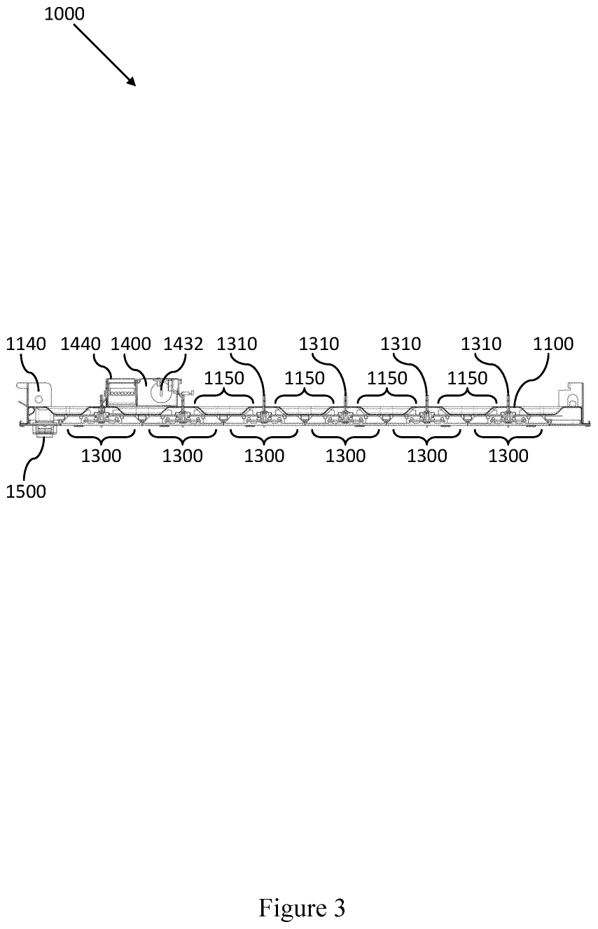

FIG. 2 further shows two mutually perpendicular axes A and B, respectively. These axes are for indicating the locations of cross sections of the luminaire 1000, the views of which are included in FIGS. 3 to 6.

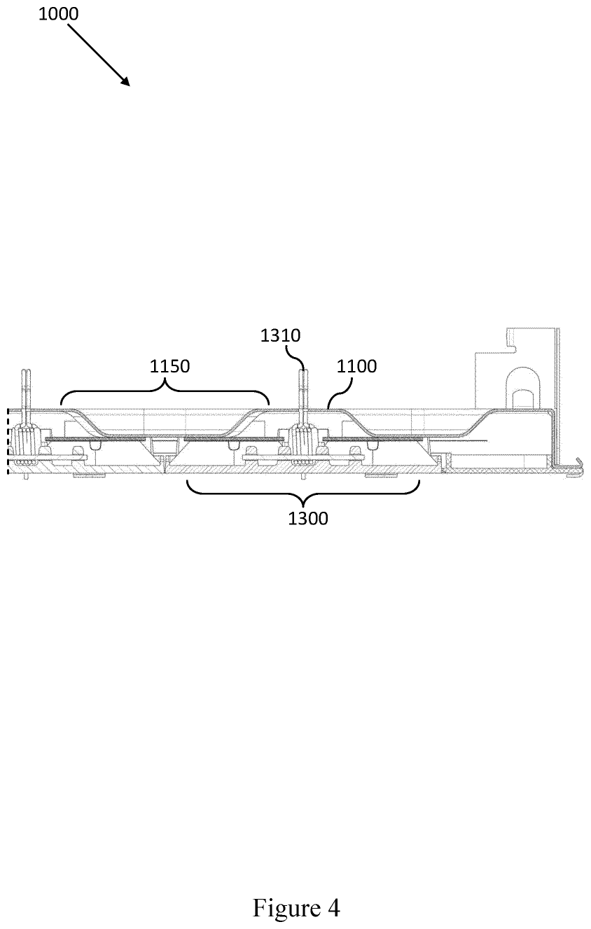

FIG. 3 is a view of a cross section of the luminaire 1000 along axis A as shown in FIG. 2. FIG. 4 is a close-up of the view of FIG. 3.

In the views of FIGS. 3 and 4 it can be seen that the luminaire 1000 has six lighting modules 1300 arranged next to each other.

The dimples 1150 formed in the back plate 1100, and the springs 1310 connecting the lighting modules 1300 to the back plate 1100, are also visible in the views of FIGS. 3 and 4. For the sake of clarity, not all dimples 1150 and springs 1310 have been indicated with a reference numeral.

Each lighting module 1300 has an axis of elongation that is perpendicular to the axis A (i.e., perpendicular to the views of FIGS. 3 and 4). On either side of its axis of elongation, a lighting module 1300 is supported by a linear arrangement of dimples 1150. The outermost linear arrangement of dimples 1150 is only supporting the outermost lighting modules 1300, while each of the remaining linear arrangements of dimples 1150 are supporting two adjacent lighting modules 1300.

Furthermore, it can be seen that a sensor 1500 is located at the sensor location 1210.

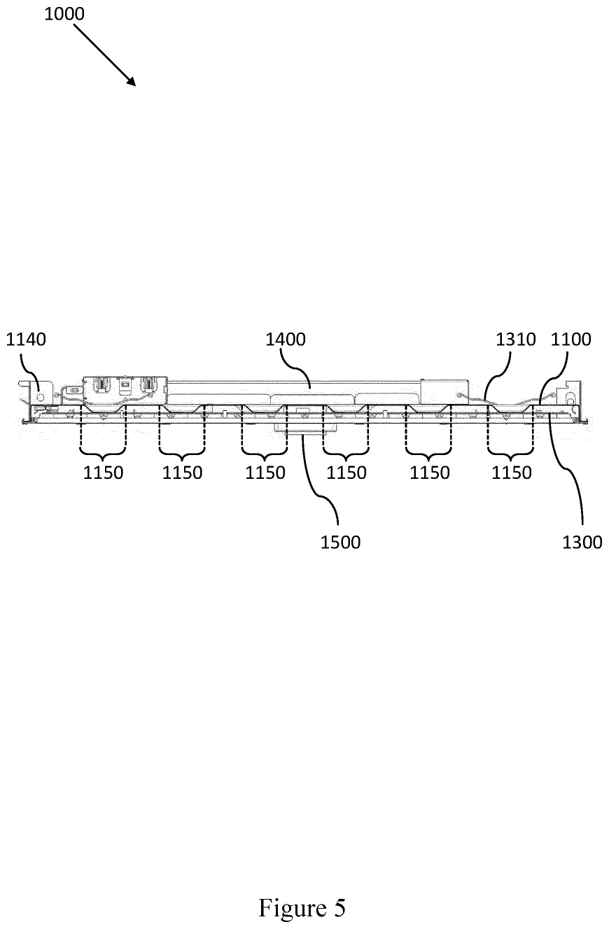

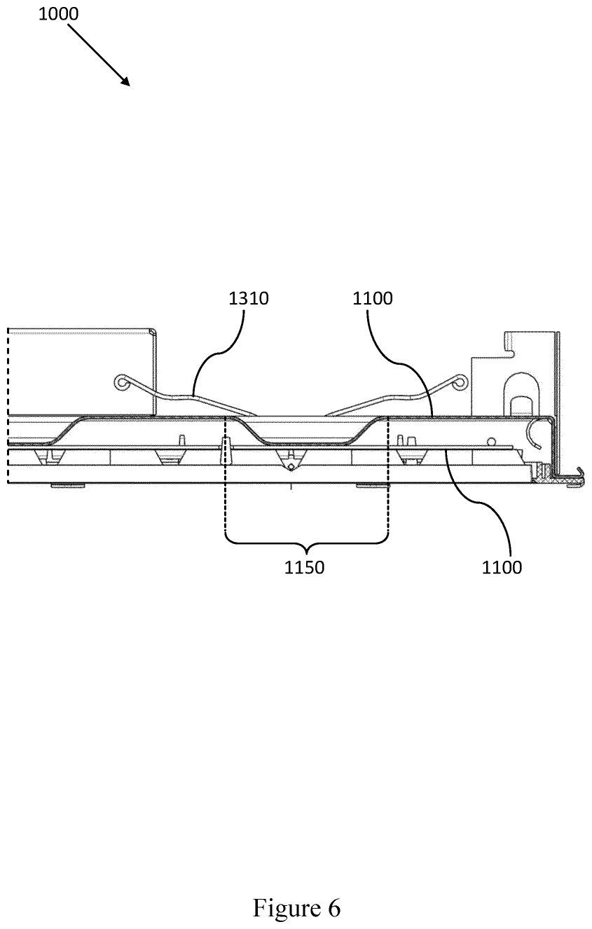

FIG. 5 is a view of a cross section of the luminaire 1000 along axis B as shown in FIG. 2. FIG. 6 is a close-up of the view of FIG. 5.

The views of FIGS. 5 and 6 show one lighting module 1300 having an axis of elongation that is parallel to the axis B (i.e., oriented horizontally in the views of FIGS. 3 and 4). In a direction along, and on either side of, its axis of elongation, the lighting module 1300 is supported by a linear arrangement of dimples 1150. In the example illustrated here, the linear arrangement contains six dimples 1150.

The dimples 1150 provide the back plate 1100 with an improved strength and/or rigidity.

The dimples 1150 also serve as spacers to provide, between the lighting module 1300 and the back plate 1100, sufficient space for accommodating, for example, additional electrical components.

The dimples 1150 further serve as heat dissipation elements for transferring heat generated by the lighting module 1300 when the luminaire 1000 is in operation to the back plate 1100. The arrangement of the dimples 1150 is designed such that any heat generated in parts of the lighting module 1300 that are not in direct contact with a dimple 1150 can still be sufficiently dissipated via the nearest dimples 1150.

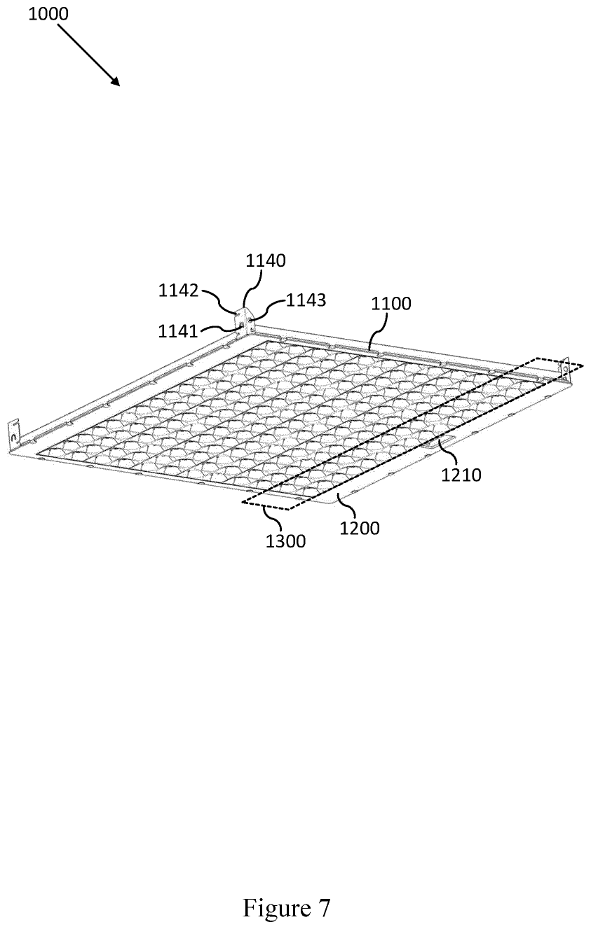

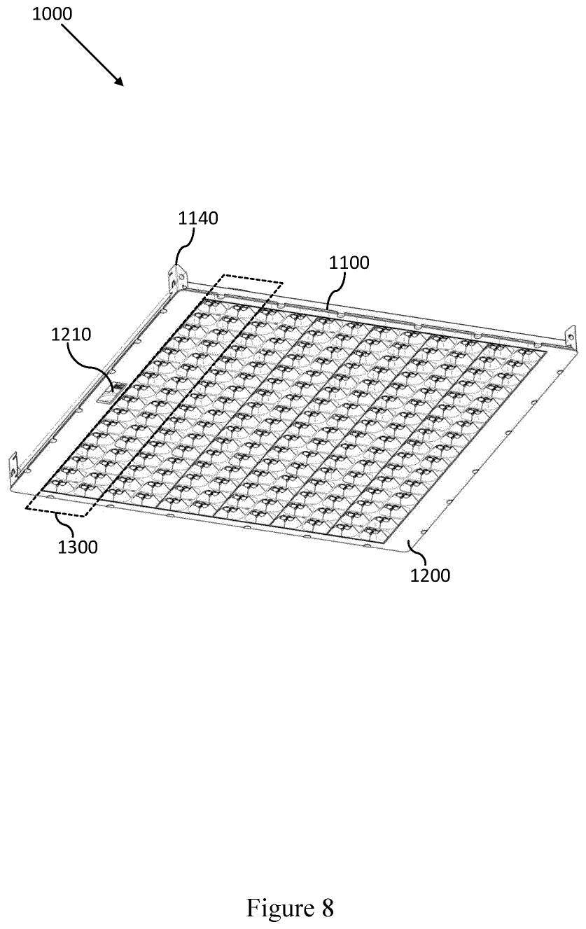

FIGS. 7 and 8 are views of the luminaire 1000 in a so-called closed configuration.

In FIGS. 7 and 8, the mounting means 1140 are shown in an upright position. The mounting means 1140 may be bent flat onto the back side of the luminaire 1000 to avoid damage during transportation of the luminaire 1000. During installation they can then be bent into the upright position as shown in FIG. 7.

The mounting means 1140 may be removable and/or replaceable to enable easy reuse of the luminaire 1000 in another location.

After first use, the mounting means 1140 may have been deformed, in which case it could be better to renew them at a re-install of the luminaire 1000.

Each of the mounting means 1140 shown in FIG. 7 has a first clip 1141, a second clip 1142, and a cable connection 1143. The first clip 1141 and the second clip 1142 may be used as bottom and top clips, respectively, for connecting the luminaire 1000 to a T-grid ceiling system. The cable connection 1143 may be used as connection for an earthquake cable.

Also visible in FIGS. 7 and 8 is the sensor location 1210 in the front rim 1200, and six lighting modules 1300, of which one is indicated in the dashed area labelled with reference numeral 1300. For each lighting module, only the cup plate is visible in the view of FIGS. 7 and 8.

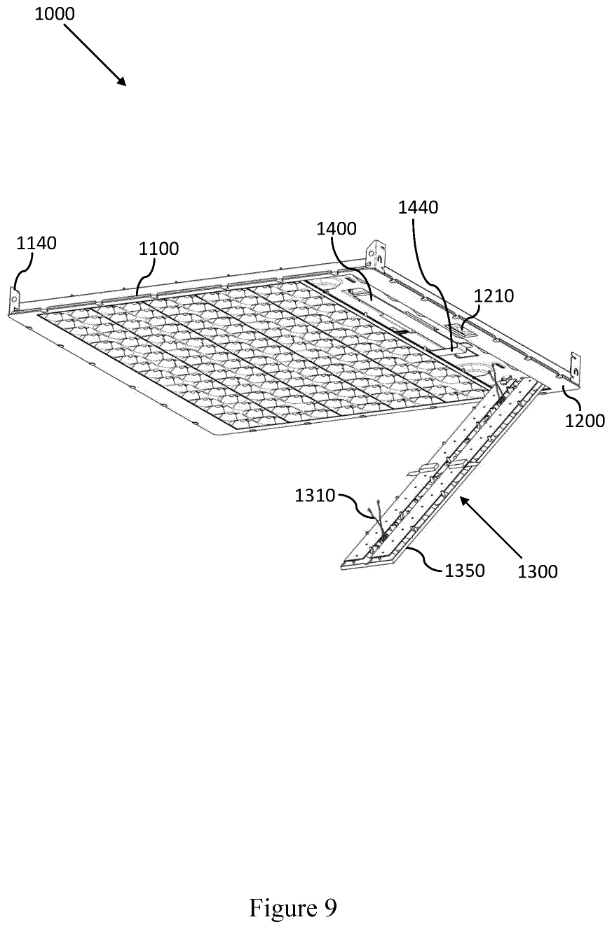

FIG. 9 is a view of the luminaire 1000 in a so-called service (or open) configuration.

The lighting module 1300 indicated in this FIG. 9 is the same as the one shown in the dashed area indicated in FIG. 7.

Compared to FIG. 7, this lighting module 1300 is now in a tilted position relative to the back plate 1100. At least one of the springs 1310 is fully detached from the back plate 1100, thereby allowing the lighting module 1300 to be in the tilted position.

The view of FIG. 9 clearly illustrates that the springs 1310 are designed for easy disassembly. This is because the legs of each spring 1310 have a length that is such that the lighting module 1300 can drop down far enough to allow easy disassembly.

The lighting module 1300 now being in the tilted position allows a view of the driver 1400, that would otherwise be covered by the lighting module 1300 in case the luminaire 1000 is in the closed configuration of FIG. 7.

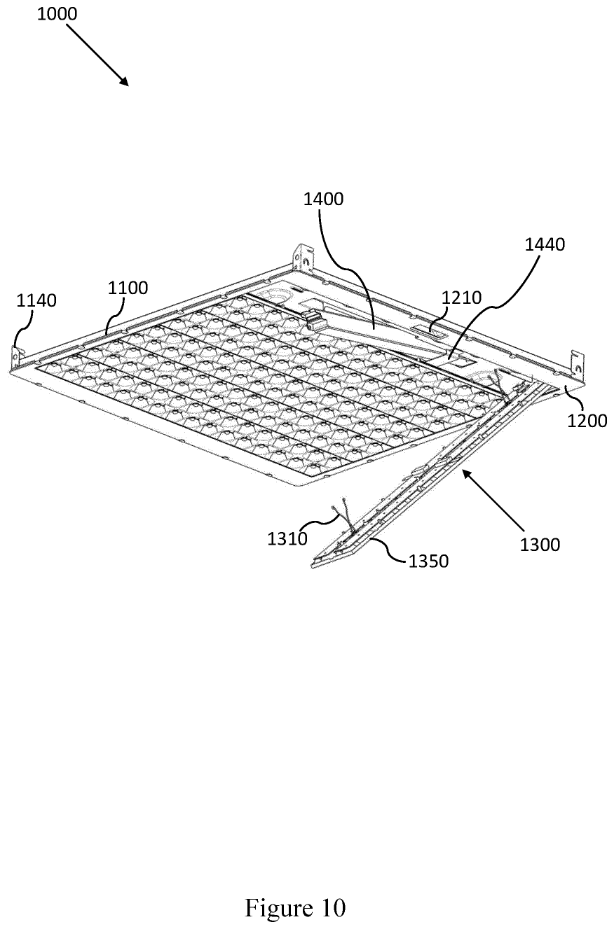

FIG. 10 is again a view of the luminaire 1000 in a service configuration, but now the driver 1400 is also in a tilted position relative to the back plate 1100.

One side of the driver 1400, being a low-voltage side of the driver 1400, is fully detached from the back plate 1100, while the opposite side of the driver 1400, being a high-voltage side of the driver 1400, is still kept in place by the assembly bridge 1440.

The assembly bridge 1440 combines multiple functionalities.

The assembly bridge 1440 is arranged to prevent a drop of the driver 1400 when the low-voltage side of the driver 1400 is detached from the back plate 1100.

The assembly bridge 1440 ensures a correct z-position of the lighting module 1300 when the luminaire 1000 is in a closed configuration such as illustrated in FIG. 7. For the lighting modules 1300 that are not covering the driver 1400 when the luminaire 1000 is in a closed configuration, the dimples in the back plate 1100 are providing a similar alignment function.

The assembly bridge 1440 is arranged to dissipate heat away from the lighting module 1300 when the luminaire 1000 is in operation.

In the closed configuration of the luminaire 1000, the driver 1400 is only covered by a single lighting module 1300. This means that only one lighting module 1300 needs to be removed for the driver 1400 to be replaced.

The driver 1400 is located in the luminaire 1000 at a position immediately adjacent to the sensor location 1210. Because the sensor location 1210 remains visible even when the luminaire 1000 is in a closed configuration, it serves as a marker for indicating the location of the driver 1400, so that a user knows which lighting module 1300 to remove in case a replacement of the driver 1400 is to take place.

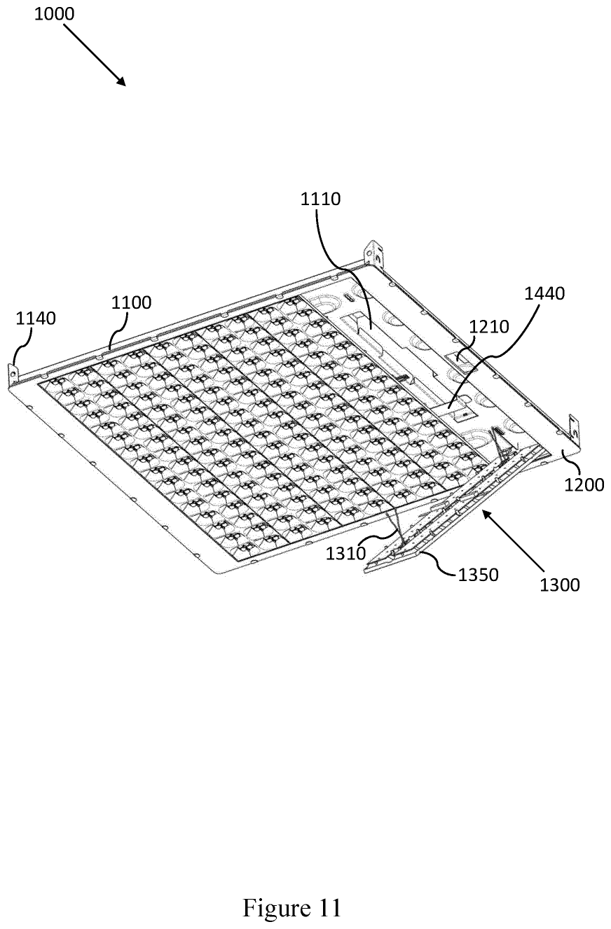

FIG. 11 is a view of the luminaire 1000 in a service configuration, similar to the view of FIG. 10, but now the driver 1400 has been removed from the luminaire 1000.

With the driver 1400 being removed from the luminaire 1000, the rectangular opening 1110 in the back plate 1100, wherein the driver 1400 was previously located, is now clearly visible.

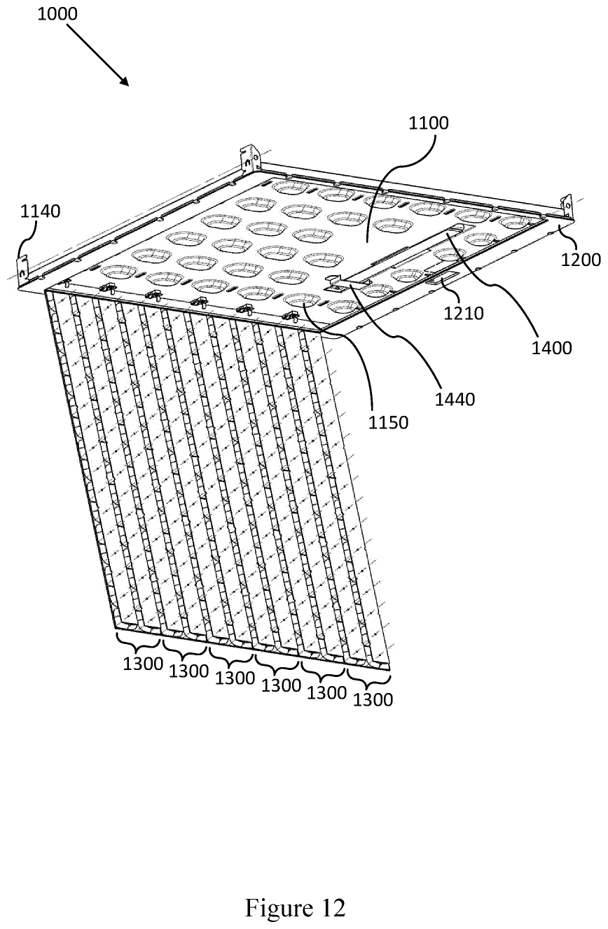

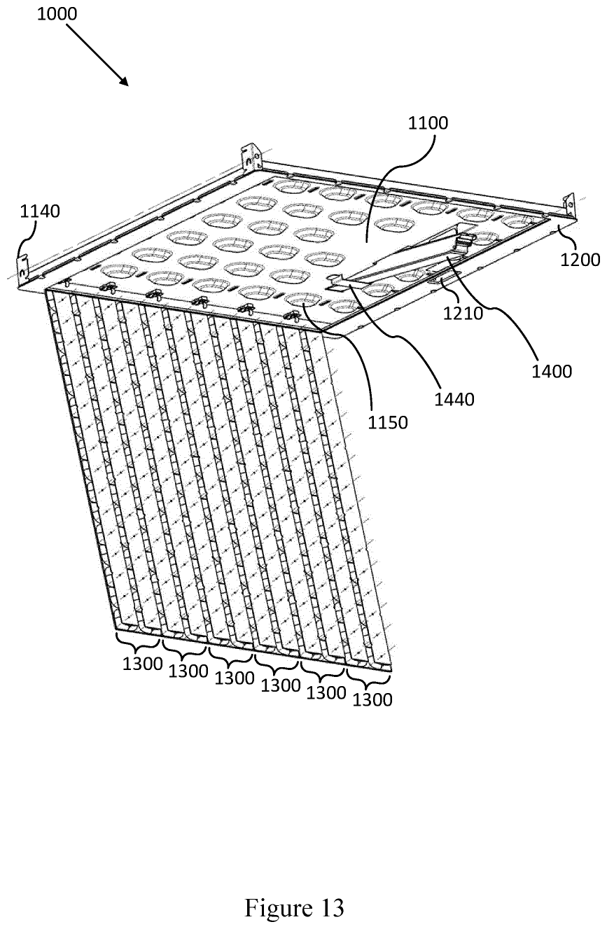

FIGS. 12 and 13 are views of the luminaire 1000 in a service configuration, similar to the view of FIG. 9, but now with all lighting modules 1300 in a tilted position.

In the view of FIG. 12, the driver 1400 is assembled into the luminaire 1000, while in the view of FIG. 13 it is partly detached (at the low-voltage side of the driver 1400) and in a tilted position relative to the back plate 1100.

In the views of FIGS. 12 and 13, the back plate 1100 is exposed and therefore clearly visible. Also clearly visible in these views are the dimples 1150 in the back plate 1100, protruding in a direction towards the lighting modules 1300.

When the luminaire 1000 is used as a ceiling luminaire and attached to a ceiling grid, the back plate 1100 may be arranged to fully cover an opening of the ceiling grid so as to close the ceiling.

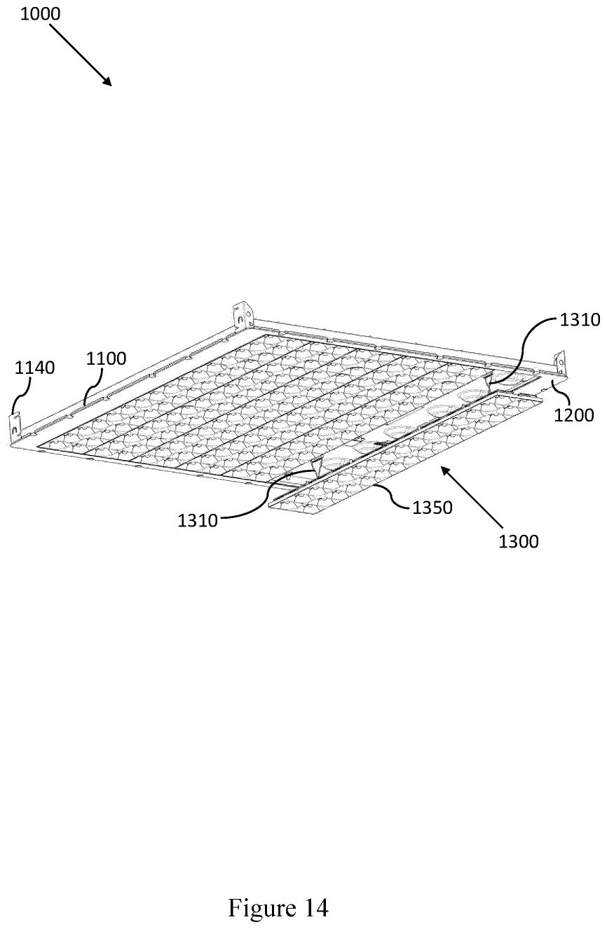

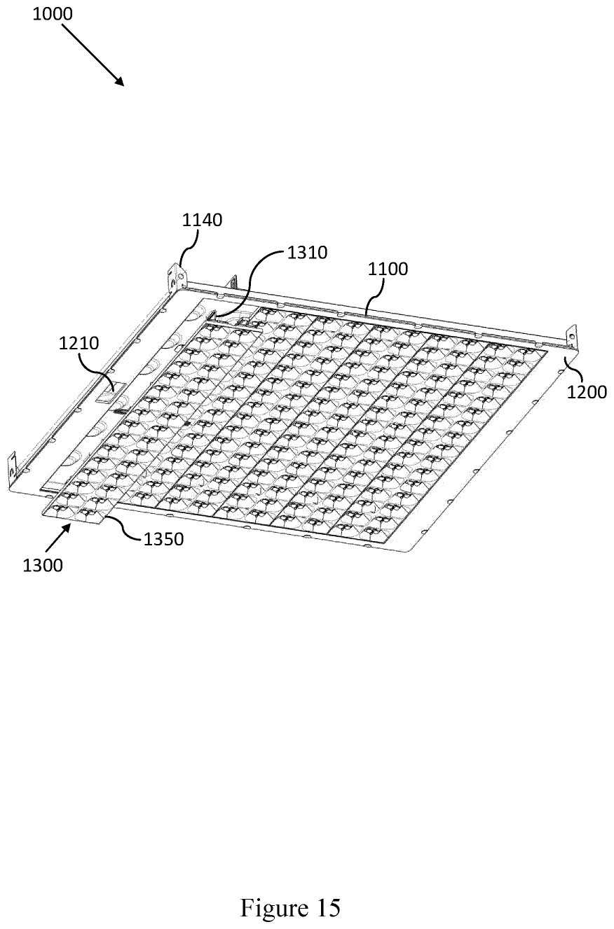

FIGS. 14 and 15 are views of the luminaire 1000 (from different viewing angles), showing one of the lighting modules 1300 in a drop-down position.

Both springs 1310 are still attached to the back plate 1100, but in such a way that the lighting module 1300 hangs under the back plate 1100.

The springs 1310 are constructed in such a way that they provide a geometrical barrier for falling out. The springs 1310 may even be constructed such that even at much higher loads than specified in the relevant UL requirements, the lighting module 1300 will not come loose from the luminaire 1000.

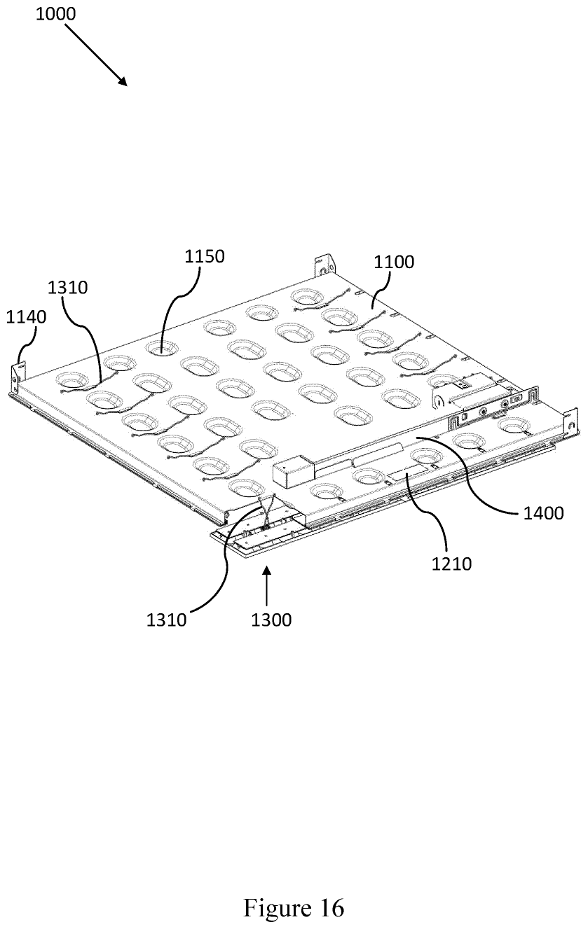

FIG. 16 is a view of a back side of a luminaire 1000.

In the bottom left corner of the view of FIG. 16, part of the back plate 1100 has been omitted to provide a better view of the lighting module 1300, which is in a drop-down position.

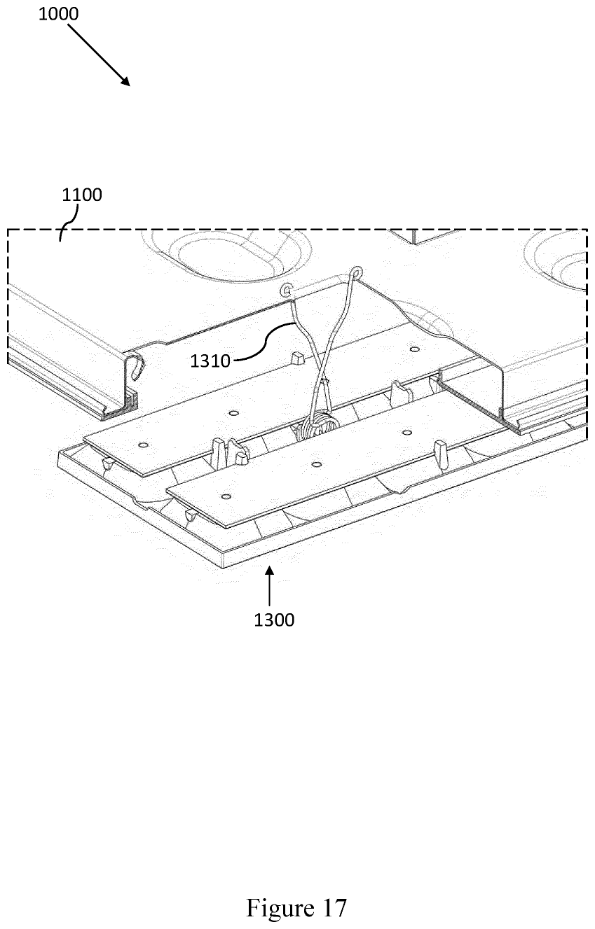

FIG. 17 is a close-up of the view of FIG. 16, showing the bottom left corner where the drop-down lighting module 1300 is exposed.

Similar to what is shown in FIGS. 14 and 15, the springs 1310 that hold the drop-down lighting module 1300 are still attached to the back plate 1100, but in such a way that the lighting module 1300 hangs under the back plate 1100.

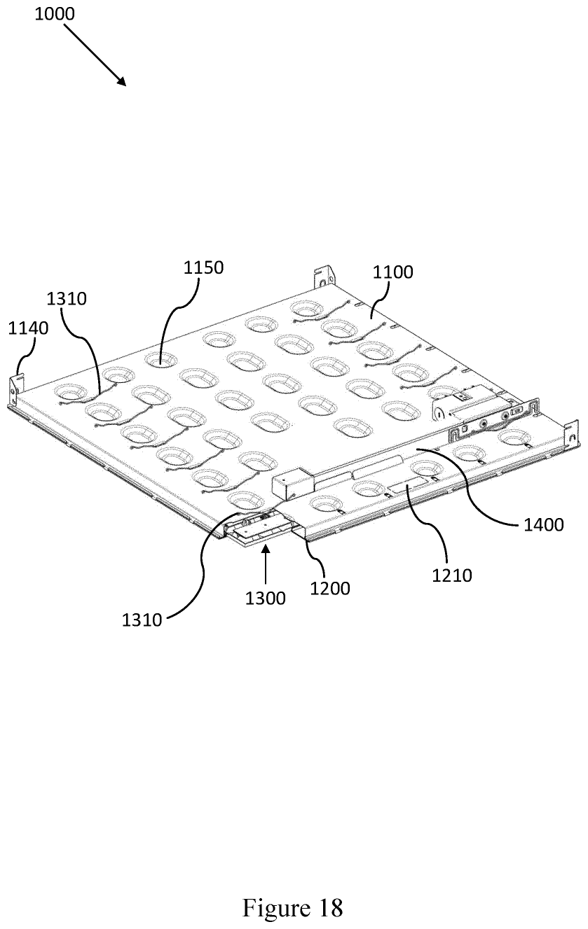

FIG. 18 is a view of a back side of a luminaire 1000.

In the bottom left corner of the view of FIG. 18, part of the back plate 1100 has been omitted to provide a better view of the lighting module 1300, which is in an assembled position.

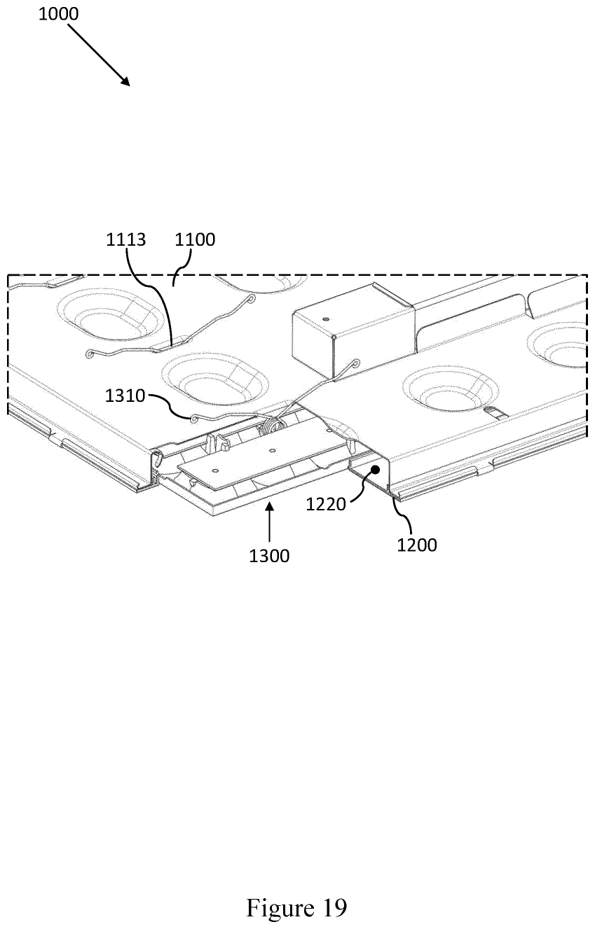

FIG. 19 is a close-up of the view of FIG. 18, showing the bottom left corner where the assembled lighting module 1300 is exposed.

In an assembled position, the legs of the spring 1310 have been inserted into the back plate 1100 via a spring mounting opening, and they press against a back surface of the back plate 1100, thereby keeping the lighting module 1300 in place.

As can be clearly seen in the close-up view of FIG. 19, the front rim 1200 has a tray 1220 that can be used to hold electrical cables, for example during replacement of the lighting module 1300.

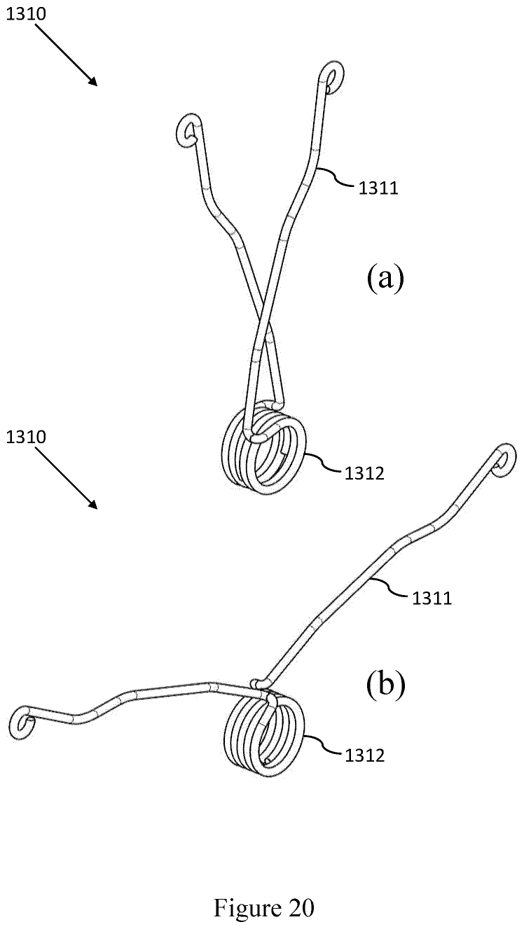

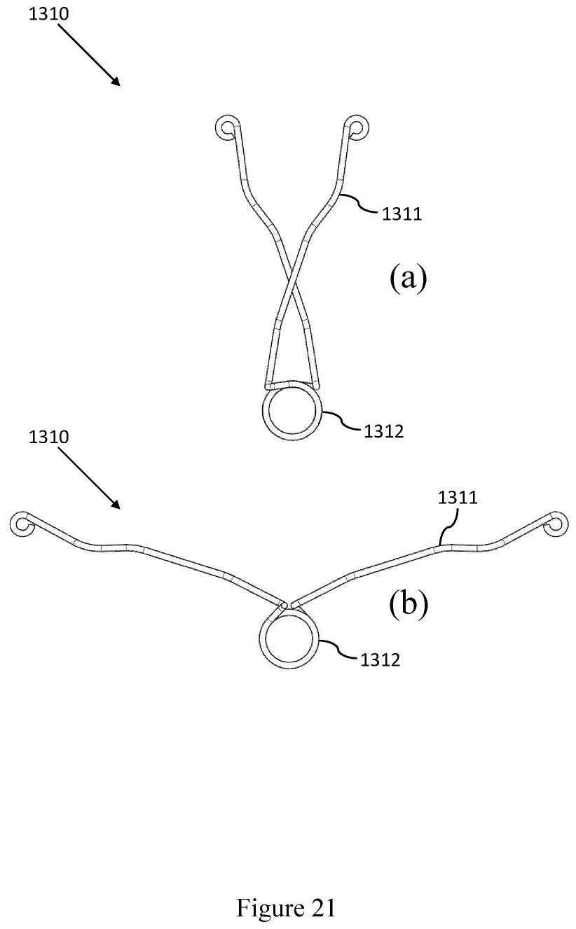

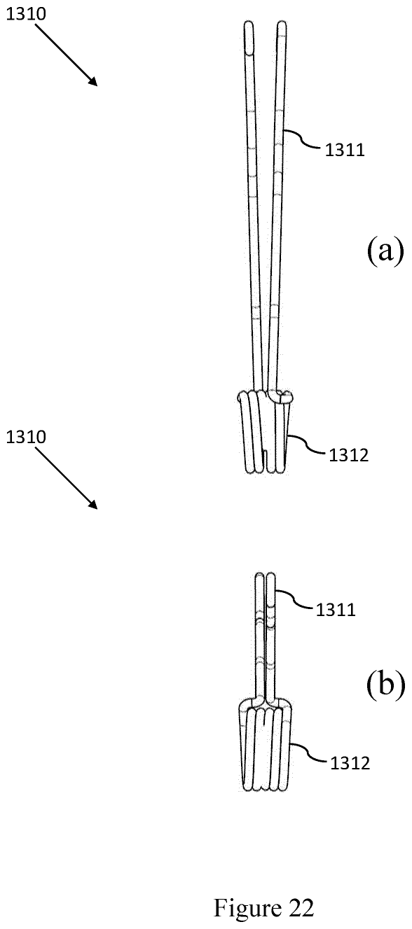

Each of FIGS. 20 to 22 show a tensioned state and a relaxed state of a spring 1310, in perspective view, front view, and side view, respectively.

The tensioned states shown under (a) of FIGS. 20 to 22 are the states of the spring 1310 when at least one of the ends of a lighting module 1300 hangs under the back plate 1100, such as when the lighting module 1300 is in a drop-down position or in a tilted position.

The relaxed states shown under (b) of FIGS. 20 to 22 are the states of the spring 1310 when the lighting module 1300 is in an assembled position.

In the perspective views of FIG. 20 it can be seen that the spring 1310 has a double bend where the legs 1311 connect to the coil 1312. Such a double bend allows for a more stable behavior of the spring 1310.

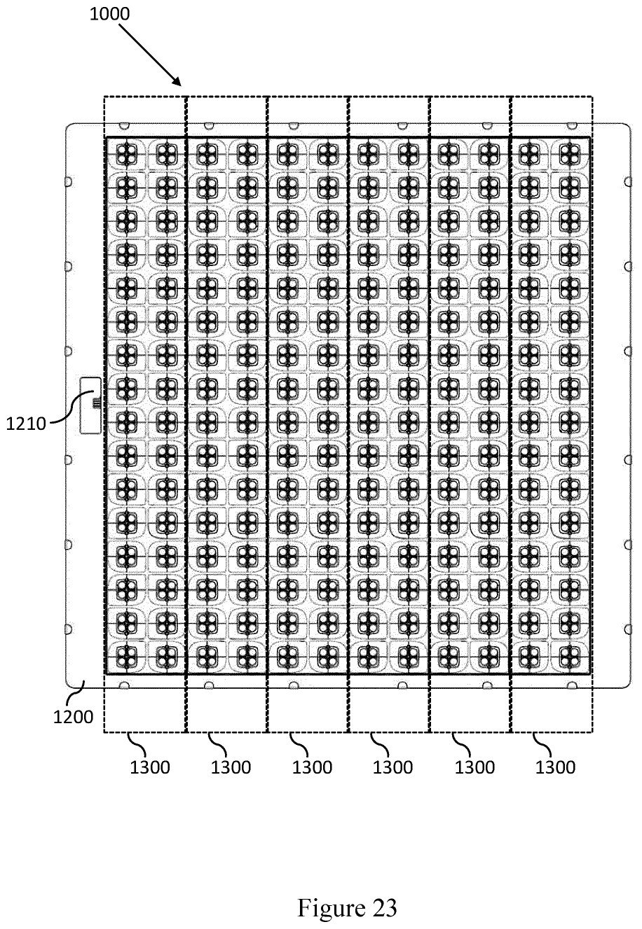

FIG. 23 is a front view of the luminaire 1000 in a closed configuration.

The luminaire 1000 has six lighting modules 1300, all fully attached to the back plate 1100 (the latter not being visible in this view).

The lighting modules 1300 all have an elongated shape, and they are arranged next to each other with their axes of elongation being oriented in parallel directions, and with essentially no gap in between adjacent lighting modules 1300.

The arrangement of the lighting modules 1300 is such that the luminaire 1000, when mounted in a ceiling, is perceived as a “texture” in the ceiling instead of a “technical” housing.

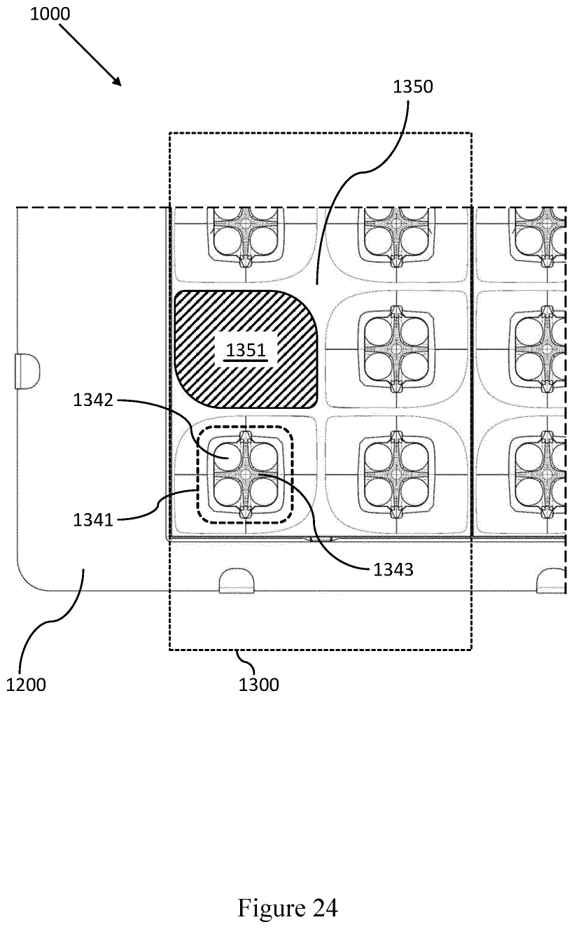

FIG. 24 is a close-up of the view of FIG. 23. In particular, it shows a close-up of the lower left corner of the view of FIG. 24, wherein part of the lighting module 1300 is visible.

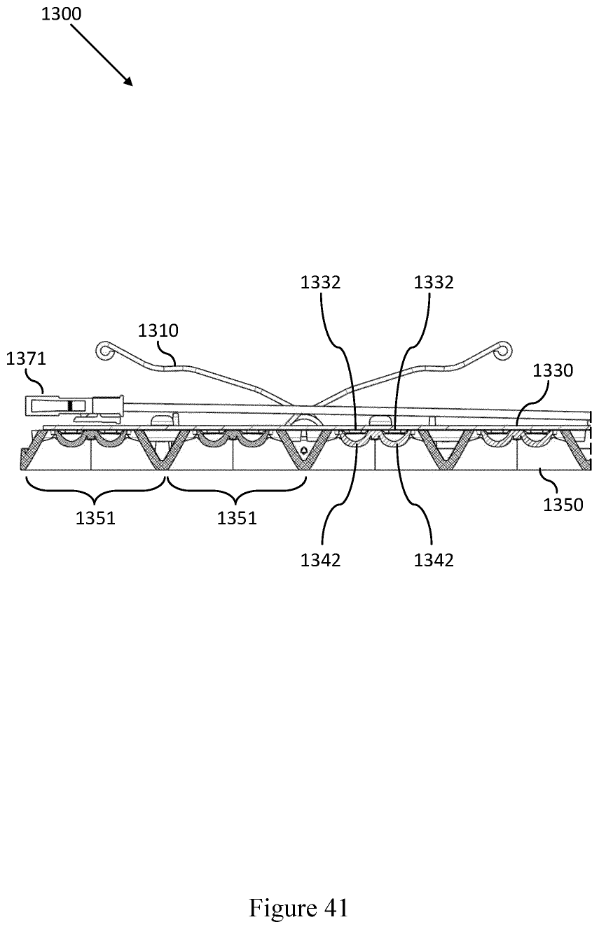

The lighting module 1300 has a cup plate 1350, of which also a part is visible in the close-up of FIG. 41.

One of the cups of the cup plate 1350 is indicated with the hatched area labelled with reference numeral 1351. The cup 1351 has a cross section with a shape that resembles a rhomboid leaf shape. In the cup plate 1350, clusters of four such cups 1351 can be identified, wherein for each cluster the cups 1351 are arranged around a central point so as to form a rotationally symmetric cup arrangement.

The invention is, however, not limited to any particular cup shape. Different shapes may be designed to allow for different patterns and/or textures in the luminaire 1000.

Each cup 1351 has an open base wherein a lens cluster 1341 of four lenses 1342 is positioned, the four lenses 1342 being arranged in a substantially square 2-by-2 matrix.

In the view of FIG. 24, an LED is located behind every lens 1342. In operation, each LED emits light, which is refracted by a lens 1342 before being reflected by an inner surface of a cup 1351.

The lenses 1342 may be arranged to improve light extraction from the LEDs and/or to reduce glare.

In each cup 1351, the LEDs that are located behind the lens cluster 1341 are arranged such as to increase visual comfort. For example, the LEDs may be arranged so as to be at least 9 mm apart from each other.

In each lens cluster 1341, the four lenses 1342 are separated from each other by means of a cross-shaped wall structure 1343. Such a cross-shaped wall structure 1342 may be arranged to provide an additional cutoff. Preferably, for each LED, the cutoff angle towards the inner surface of the cup 1351 is approximately equal to the cutoff angle to the cross-shaped wall structure 1343.

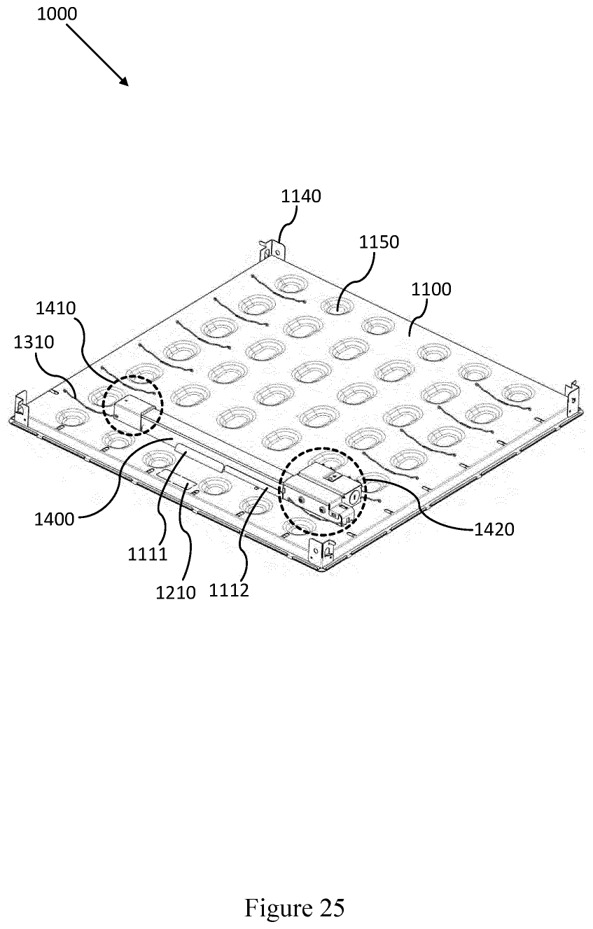

FIG. 25 is a view of a back side of the luminaire 1000 in a closed configuration.

All lighting modules 1300 are attached to the back plate 1100 by means of the springs 1310, but because the view is from the back side of the luminaire 1000, the lighting modules are not visible in FIG. 25.

The driver 1400 has a support at the low-voltage side 1410. Such a support may have a fastening means (such as a screw) to keep the low-voltage side 1410 of the driver 1400 in place.

The support at the low-voltage side 1410 of the driver 1400 may further serve to close the back plate 1100 of the luminaire 1000, to for example comply with standard UL1598.

The driver 1400 is located in a driver opening in the back plate 1100. The shape of the driver opening is such that the driver 1400 fits inside. Preferably, some room is left so that a user may grasp the driver 1400 during mounting.

To prevent the driver 1400 from falling out of the driver opening, the back plate 1100 may have one or more lips for clamping to a side of the driver 1400. The view of FIG. 25 shows two such lips, labelled 1111 and 1112 respectively.

A first lip 1111 is located approximately at the center of the driver opening in the back plate 1100. This first lip 1111 is oriented at an acute angle relative to the back plate 1100, such as an angle of 45 degrees. This configuration provides the aforementioned room, such as about 6 mm, for allowing a user to grasp the driver 1400.

A second lip 1112 is located adjacent to the first lip 1111, and oriented at a substantially right angle relative to the back plate 1100, to provide a relatively large surface for clamping a side of the driver 1400.

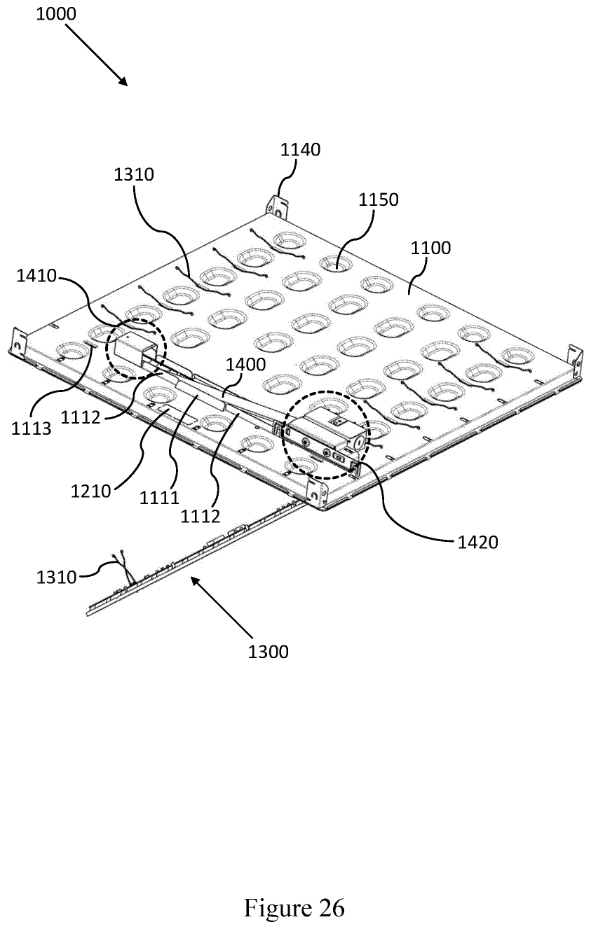

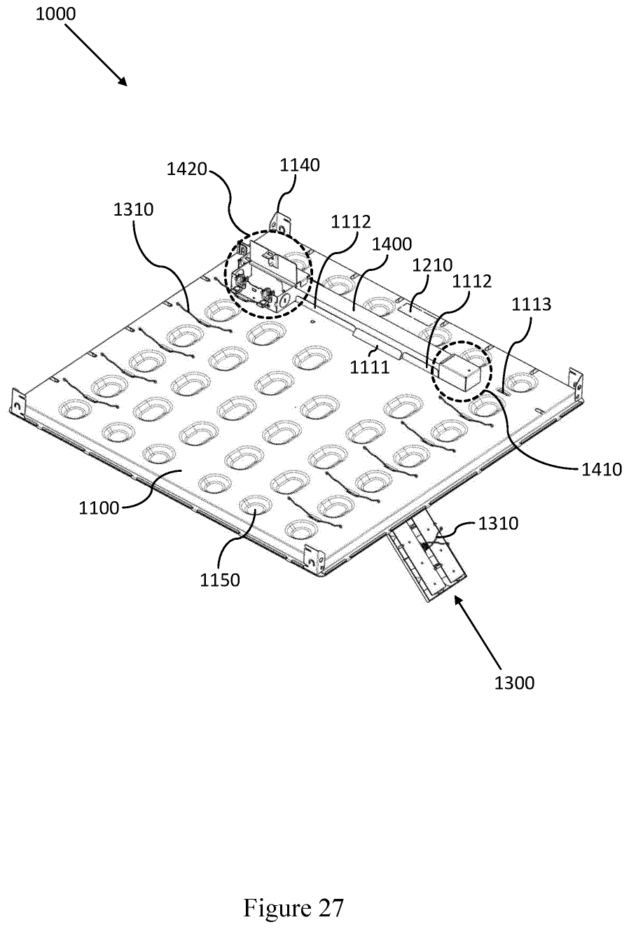

FIGS. 26 and 27 are both views of a back side of the luminaire 1000 in a service configuration, but from different viewing angles.

In FIG. 26, the driver 1400 is in a tilted position (i.e., disconnected at the low-voltage side 1410 while still connected at the high-voltage side 1420).

In FIG. 27, the driver 1400 is still fully detached to the luminaire 1000.

The lighting module 1300 that is located in the luminaire 1000 below the driver 1400 is in a tilted position. The spring 1310 that is arranged to attach this lighting module 1300 to the back plate 1100 via a spring mounting opening 1113 located at the low-voltage side 1410 of the driver 1400 has been fully disconnected from the back plate 1100 allowing the lighting module 1300 to be in the tilted position.

The driver 1400 is disconnected from the support at the low-voltage side 1410, and also shown in a tilted position.

Except for the tilted lighting module 1300, the other lighting modules of the luminaire 1000, which are not visible in the views of FIGS. 26 and 27, are all fully attached (or secured) to the back plate 1100, each by means of two springs 1310 of which the legs are protruding through a spring mounting opening 1113 and lying substantially flat on the back plate 1100.

Also visible in the views of FIGS. 26 and 27 are the first and second lips 1111 and 1112, respectively. From these views it can be seen that two first lips 1111 are provided on opposite sides of the driver opening in the back plate 1100. On each side of the driver opening, two second lips 1112 are provided on both sides of the first lip 1111. The invention is, however, not limited to any particular number or shape or arrangement of lips, and also alternative means for preventing the driver 1400 from falling out of the driver opening may be used.

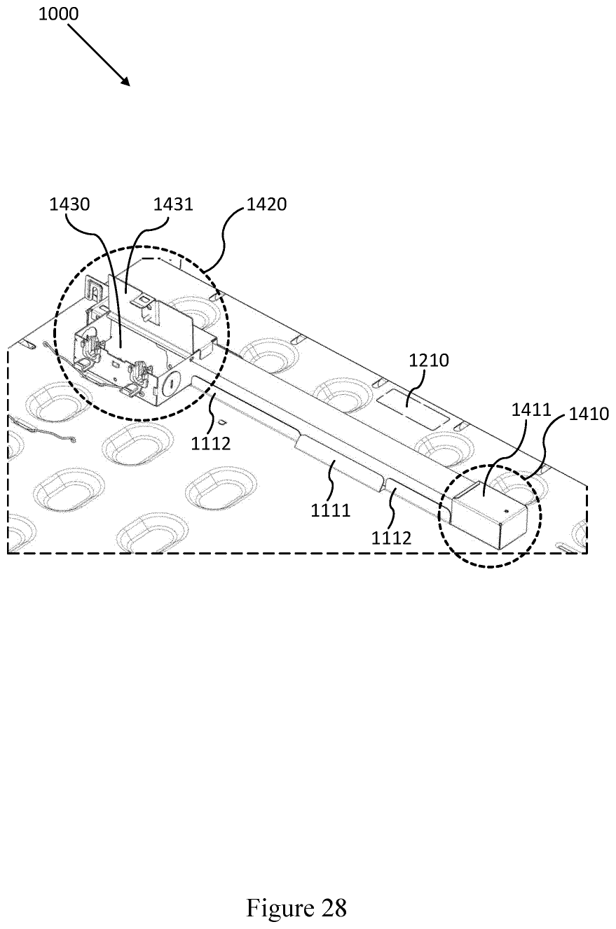

FIG. 28 is a close-up of the view of FIG. 27, showing part where the driver 1400 is located.

At the low-voltage side 1410, the driver 1400 is covered by a cover 1411. The cover 1411 is arranged to provide support and to close the back plate 1100 of the luminaire 1000. The driver 1400 can be attached to the cover 1411 by means of screw connection. In the view of FIG. 27, the hole of the screw connection is visible on the top part of the cover 1411.

The cover 1411 is typically made from a metal, which may be spot-welded to create a sufficiently rigid structure, and which may have a hem, being a rim or edge folded back on itself, to create a smooth edge and to further increase strength and/or rigidity.

At the high-voltage side 1420, the driver 1400 is partly inserted into to a junction box 1430. In the view of FIG. 27, the junction box 1430 has a lid 1431 that is shown in an open position.

The remaining part of the driver 1400, being the part not inserted into the junction box 1430 nor covered by the cover 1411, is arranged to close the back plate 1100 of the luminaire 1000.

In other words, when the driver 1400 is fully attached to the luminaire 1000, a first part at the low-voltage side 1410 is covered by the cover 1411 and a second part at the high-voltage side 1420 is inserted in the junction box 1430. The cover 1411, the junction box 1430, and a remaining third part of the driver 1400, located between the first part and the second part, together serve to close the back plate 1100 of the luminaire 1000. Because the driver 1400 is used to close the back plate 1100, the use of material is reduced, which in turn improves the sustainability of the luminaire 1000.

The above configuration of the luminaire 1000 allows the latter to be serviced from the front side, being the side that faces the space wherein the luminaire 1000 is to be installed.

The driver 1400 can first be disconnected at the low-voltage side 1410 by releasing the screw connection to the cover 1411. Then, the driver 1400 can be moved in a direction from the low-voltage side 1410 towards the high-voltage side 1420. Part of the driver 1400 slides into the junction box 1430, thereby creating sufficient space at the low-voltage side 1410 to allow the driver 1400 to be tilted away from the back plate 1100.

Because the electrical connection to the junction box 1430 is made by means of a relatively long wire, the driver 1400 can be taken out of the junction box 1430, while still electrically connected to it. When fully out of the junction box 1430, the driver 1400 can be electrically disconnected.

The junction box 1430 has sufficient interior space to allow the driver 1400 to be slid into it and to accommodate the extended wire. In an assembled state, the extended wire is in a coiled configuration within the junction box 1430.

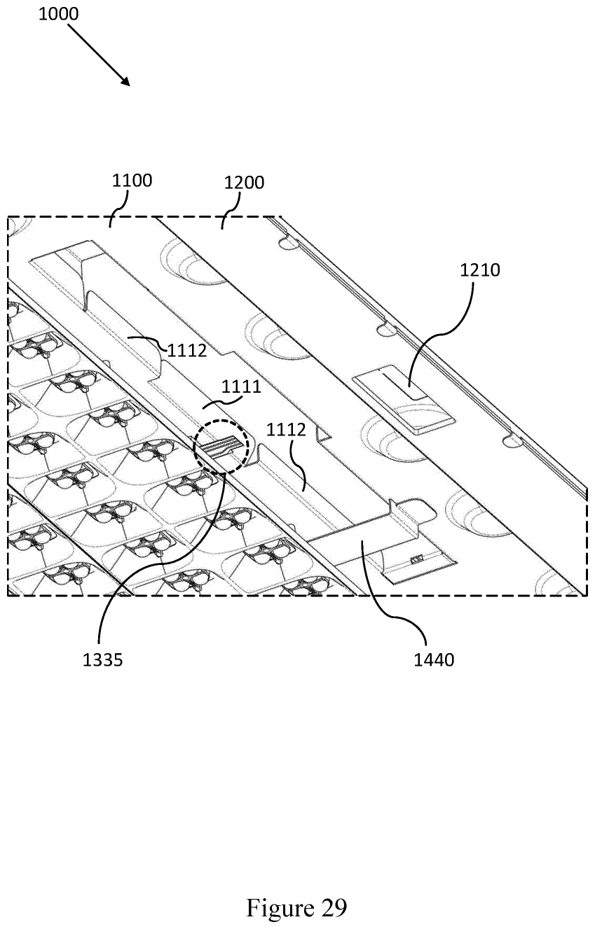

Similar to FIG. 28, FIG. 29 is a close-up of the luminaire 1000, but now looking at the part of the luminaire 1000 from a front side, being a side of the luminaire 1000 that faces the space wherein it is meant to be installed.

In the view of FIG. 29, the driver 1400 has been removed from the luminaire 1000, leaving a rectangular driver opening in the back plate 1100.

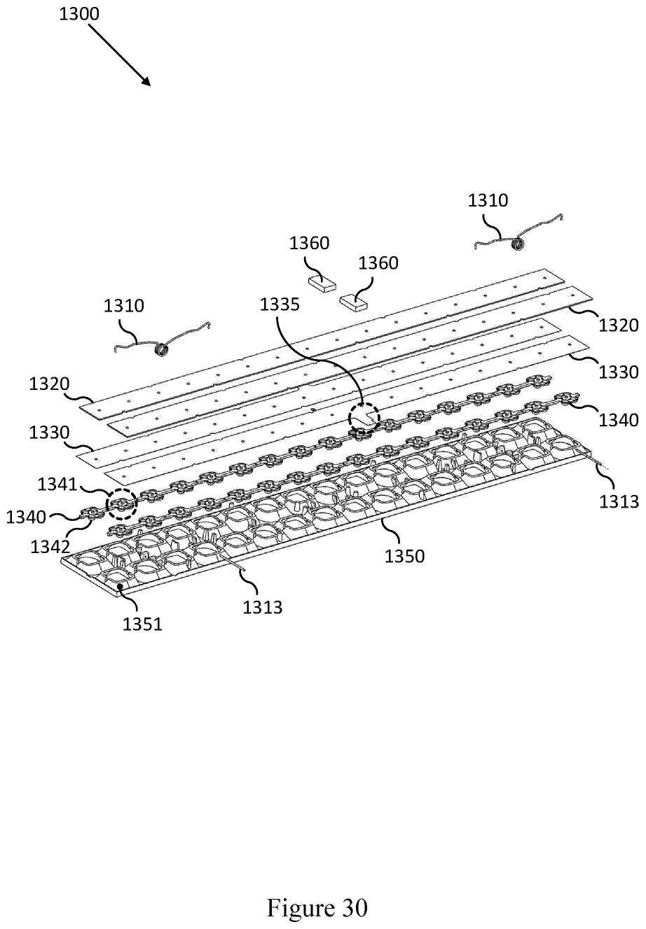

The first and second lips 1111 and 1112, respectively, are clearly visible at a side of the driver opening. The space provided by the first lip 1111 for allowing a user to grasp the driver 1400 when the latter is provided in the driver opening can also clearly be seen in the view of FIG. 30.

The assembly bridge 1440, used to keep the driver 1400 in position at the high-voltage side 1420 of the driver 1400, is clearly visible.

Also shown in FIG. 29 is a substrate tab 1335 belonging to one of the base substrates 1330. In an assembled state, this substrate tab 1335 is connected to a connector element 1360 (not shown in FIG. 29), which in turn is connected to a connector module 1370 (also not shown in FIG. 29).

FIG. 30 is an exploded view of a lighting module 1300, wherein the lighting module 1300 is in a non-assembled state.

The lighting module 1300 has an elongated shape. Although the invention is not limited to any particular shape of the lighting module, the lighting module 1300 is designed such that multiple of such lighting modules 1300 can be used to form a light-emitting line, which typically has a line width in a range from 5 to 15 centimeters, but also to form a light-emitting surface having common form factors such as 2-by-2 or 2-by-4. The lighting module 1300 has two spring rods 1313, each for holding a spring 1310. The spring rods 1313, typically made from metal, are designed to be relatively large and easy to remove at end of life, to enable separation of metal parts (such as the springs 1310) from plastic parts (such as the cup plate 1350).

The springs 1310 are for connecting the lighting module 1300 to the back plate 1100 of the luminaire 1000.

The springs 1310 are designed for easy disassembly. Each spring 1310 has two legs that are coupled together by means of a coil. The legs have a length that allows a user to insert his or her fingers between two lighting modules 1300 and to squeeze the legs of the spring 1310 to release the spring 1310 from the back plate 1100.

The springs 1310 are linked to the lighting module 1300 and not to the back plate 1100 of the luminaire 1000. This allows a simpler design of the back plate 1100, so that the latter can basically only be a structure for holding the lighting modules 1300, making it easier to redesign the back plate 1100 for other form factors. In other words, it enables use and/or re-use of lighting modules in a wide variety of luminaire designs and form factors.

The lighting module 1300 further has two lens arrays 1340. Each lens array 1340 has a linear array of 16 lens clusters 1341, and each lens cluster 1341 has four lenses 1342 arranged in a 2-by-2 matrix.

The invention is, however, not limited to any particular lens array and/or number of lens clusters and/or number of lenses per cluster.

In each lens array 1340, the 16 lens clusters 1341 are grouped in sets of two lens clusters 1341. The lens clusters 1341 constituting the set are coupled together by means of bar-shaped (or rod-shaped) connectors.

The lighting module 1300 has a cup plate 1350 comprising a plurality of cups 1351. In combination with conformal recesses in the cup plate 1350, the bar-shaped connectors allow each set of two lens clusters 1341 to be aligned to two cups 1351 of the plurality of cups 1351.

Alternatively, the lens clusters of a lens array may be grouped in sets of a different number, such as in sets of eight lens clusters. A lens array may also have all of its lens clusters coupled together by means of connectors, so that the lens array is a one-piece lens array. These alternatives have the advantage that assembly becomes easier. The connectors may be designed such as to prevent tolerance issues due to thermal expansion effects. For example, the connectors may have S-shaped bends in between adjacent lens clusters.

The lighting module 1300 has two metal plates 1320, and two base substrates 1330.

Each metal plate 1320, which may be an aluminum plate, may have a geometry that complies with industry specifications as established by the Zhaga Consortium.

Each base substrate 1330 has a plurality of LEDs interconnected by means of electrically conductive traces. The LEDs and the electrically conductive traces are not visible in the view of FIG. 30, because they are provided on the surface of the base substrate 1330 that faces the cup plate 1350.

Each base substrate 1330 has an elongated or strip-like shape. Each base substrate 1330 has a substrate tab 1335 located substantially halfway along the length of the base substrate 1330.

The substrate tab 1335 extends from the base substrate 1330 in a direction perpendicular to an elongation direction of the lighting module 1300.

The lighting module 1300 has two connector elements 1360, each for making contact to a base substrate 1330 via a respective substrate tab 1335.

The lighting module 1300 further has a connector module 1370.

The lens arrays 1310 are provided relative to the base substrates 1330 such that the lenses are placed on top of the LEDs. The position in the xy-plane is secured via alignment holes, whereas in the z-direction the lenses are clamped to the base substrates 1330 via pressure provided by the cup plate 1350.

Two or more constituents of the lighting module 1300 may be kept together by means of snap-fit connections, which has the advantage that it enables easy disassembly.

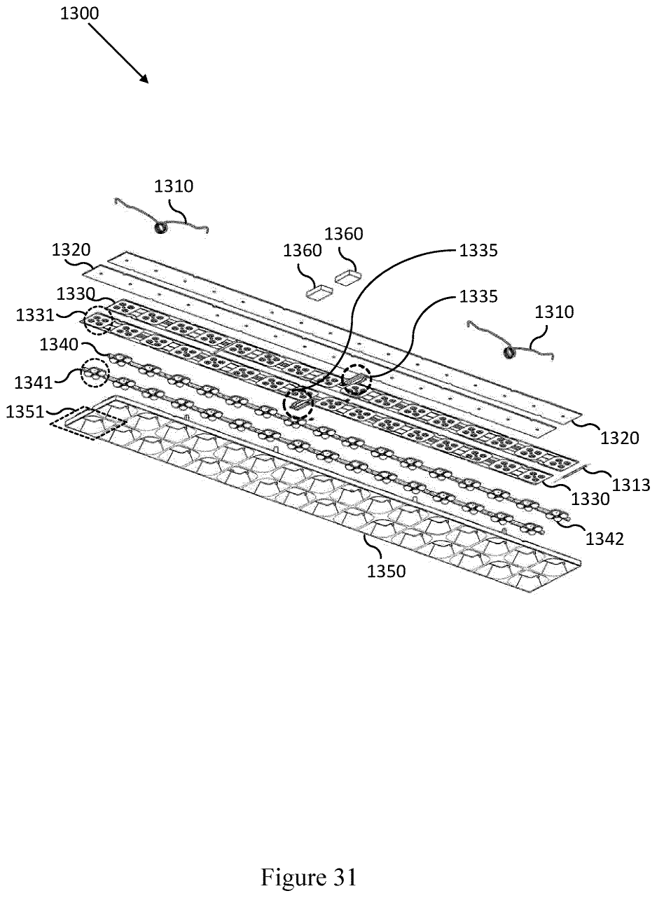

FIG. 31 is an exploded view of a lighting module 1300, wherein the lighting module 1300 is in a non-assembled state, similar to the view of FIG. 30.

Compared to FIG. 30, the exploded view of FIG. 31 provides a better view of the lens arrays 1340 and of the base substrates 1330.

Each lens array 1340 has 64 lenses, arranged in 16 lens clusters 1341 of four lenses per lens cluster 1341. The 16 lens clusters 1341 are arranged in a linear array. Each lens cluster 1341 has four lenses arranged in a 2-by-2 matrix.

Each base substrate 1330 has 64 LEDs, arranged in 16 LED clusters 1331 of four LEDs per LED cluster 1331. The 16 LED clusters 1331 are arranged in a linear array. Each LED cluster 1331 has four LEDs arranged in a 2-by-2 matrix.

The invention is, however, not limited to any particular number of lenses and/or clustering of lenses, nor to any particular number of LEDs and/or clustering of LEDs.

Also visible in FIG. 31 is that in each base substrate 1330, the LEDs are interconnected by means of electrically conductive traces.

The electrically conductive traces of a base substrate 1330 can be contacted at the respective substrate tab 1335.

The cup plate 1350 of the lighting module 1300 comprises 32 cups 1351, arranged in a 2-by-16 matrix.

In the lighting module 1300, each LED cluster 1331 is associated with a lens cluster 1341, wherein each LED of the LED cluster 1331 is associated with a lens of the lens cluster 1341. Furthermore, each associated pair of a LED cluster 1331 and a lens cluster 1341 is associated with a cup 1351.

In FIG. 31, only one such LED cluster 1331, only such lens cluster 1341, and only one cup 1351 are indicated, which together form an associated combination in the lighting module 1300.

At least the interior surfaces of the cups 1351 are reflective for light that is emitted by the LEDs. For improved efficiency, for each base substrate 1330, the surface facing the cup plate 1350 is typically also reflective for light that is emitted by the LEDs.

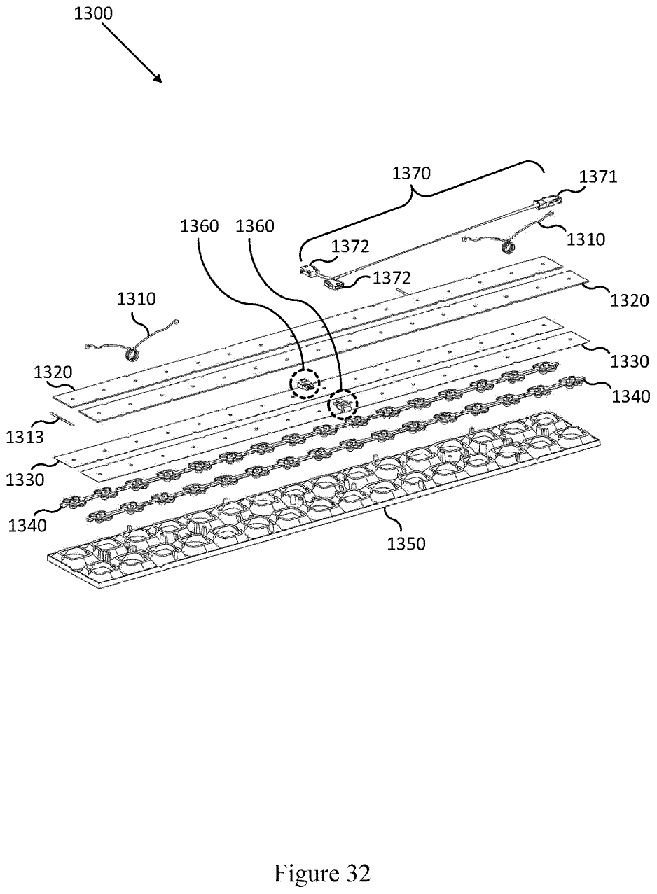

FIG. 32 is an exploded view of a lighting module 1300, wherein the lighting module 1300 is in an assembled state.

Compared to the view of FIG. 30, wherein the lighting module 1300 is in a non-assembled state, the connector elements 1360 have now been connected to the substrate tabs 1335. In the view of FIG. 32, only the connector elements 1360 are indicated with reference numerals. The substrate tabs 1335 are visible as being bent upwards from the respective base substrate 1330 and connected to a respective connector element 1360.

Also visible in FIG. 32 is the connector module 1370, for connecting to the base substrates 1330 via the connector elements 1360.

The connector module 1370 has a lighting module plug 1371 for connecting the lighting module 1300 to a cable tree that is provided at a side of the luminaire 1000, for example at the bottom side of the back side view of the luminaire 1000 shown in FIG. 2, where the clips 1120 can be used to guide the cable tree.

The connector module 1370 further has two base substrate plugs 1372, each for making connection to a respective connector element 1360 of a lighting module 1300.

The connection to the cable tree may be achieved by means of a Micro-Fit 3.0 connector system that is commercially available from Molex LLC. Such a Micro-Fit 3.0 connector system comprises a Micro-Fit 3.0 receptacle and a corresponding Micro-Fit 3.0 plug.

When using such a connector system, or a comparable connector system, the Micro-Fit 3.0 receptacle is preferably used as lighting module plug 1371 of the connector module 1370 (with the Micro-Fit 3.0 plug being provided on the cable tree), because this would allow a single-handed disconnection of the lighting module 1300 from the cable tree. The cable tree is fixed in position by means of the clips 1120, and a user only has to use one hand to hold the lighting module 1371 and to press a latch provided thereon to disconnect the lighting module plug 1371 from the cable tree.

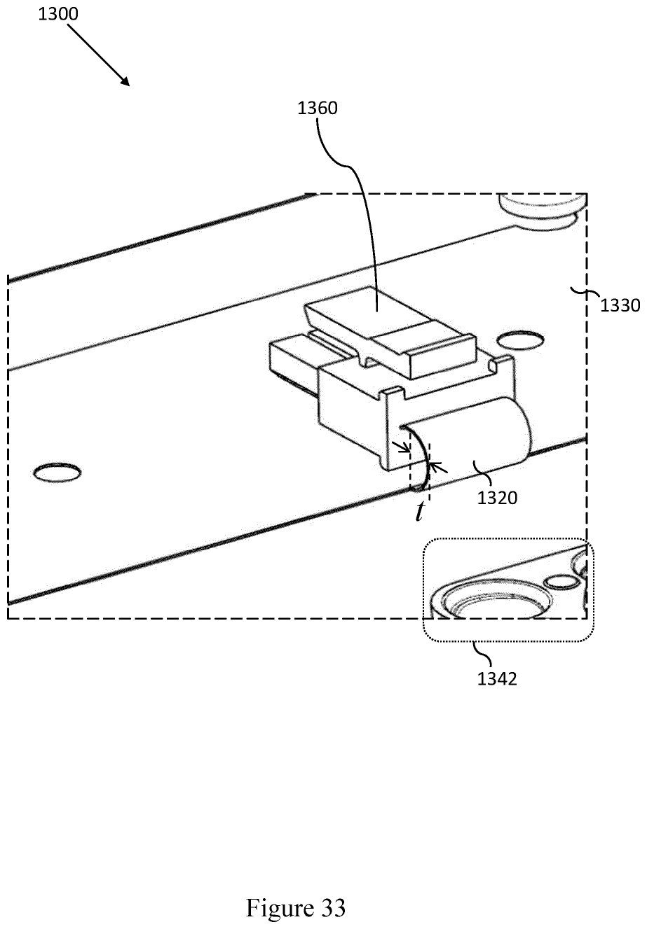

FIG. 33 is a close-up of the view of FIG. 32, showing a part wherein a connector element 1360 is connected to a substrate tab 1335.

In this view, the substrate tab 1335 is clearly visible as a fold or bend. The substrate tab 1335 is provided on a front surface of the base substrate 1330, being a surface that faces the lens array 1340, of which one lens cluster 1342 is partly visible in the view of FIG. 33. The substrate tab 1335 is folded over an edge of the base substrate 1330 to a back surface of the base substrate 1330, opposite to the front surface of the base substrate 1330. Here, the substrate tab 1335 is connected to the connector element 1360.

In an assembled state of the lighting module 1300, a metal plate 1320 is present between the connector element 1360 and the base substrate 1330. The connector module 1360 is mounted to a back surface of the metal plate 1320, opposite to a front surface of the metal plate 1320 on which the base substrate 1330 is provided.

At the location of the bent or folded substrate tab 1335, the metal plate 1320 has a rounded edge to prevent damage (such as cuts) to the substrate tab 1335.

The substrate tab 1335 is bent or folded such that it extends a distance t away from the base substrate 1330. This extension distance t is chosen such that in the assembled lighting module 1300, the bent or folded substrate tabs 1335 do not extend beyond the perimeter of the cup plate 1350, thereby avoiding any damage that may otherwise occur during assembly of the lighting module 1300 in the luminaire 1000.

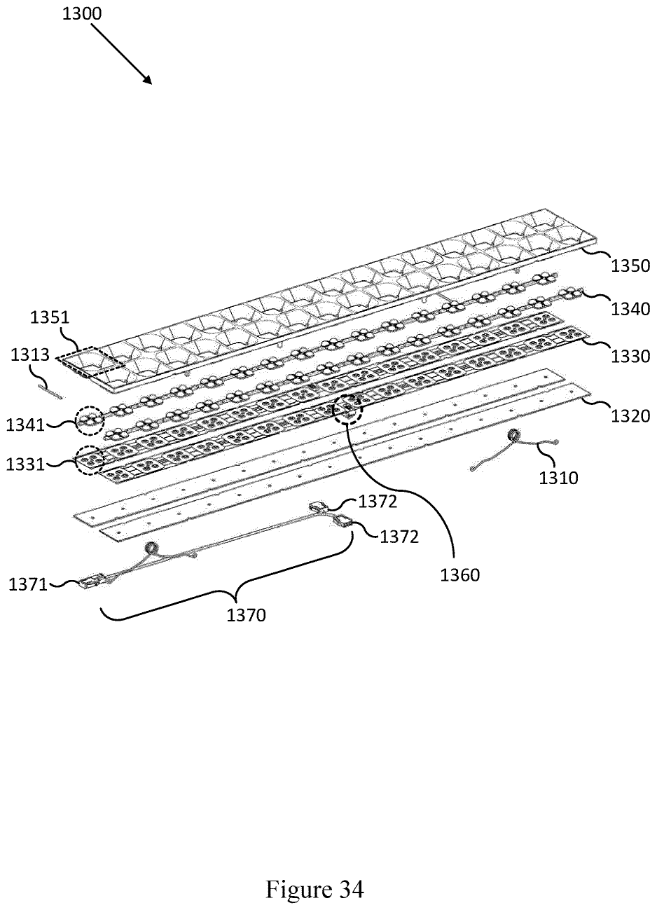

FIG. 34 is an exploded view of a lighting module 1300, wherein the lighting module 1300 is in an assembled state, similar to the view of FIG. 32.

To prevent the cable of the connector module 1370 from becoming squeezed between the lighting module 1300 and a dimple 1150 of the back plate 1100, a cable guiding means (for example a metal rod) may be positioned in the vicinity of the spring 1310 closest to the connector module 1370, to guide the cable of the connector module 1370 close to the spring 1310. Note that such a cable guiding means is not shown in FIG. 34.

Each base substrate 1330 may have a solder mask with a relatively high reflectivity for light emitted by the LEDs. To avoid unnecessary material usage, such a solder mask may only be applied at a location of the base substrate 1330 that corresponds to a base of a cup 1351 of the cup plate 1350.

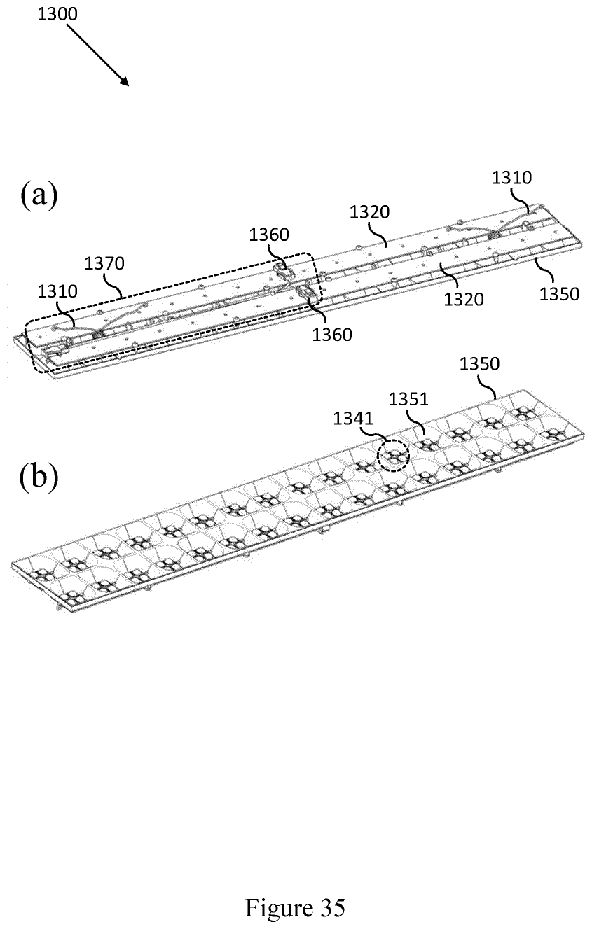

FIGS. 35, 36, 37, 38 and 39 are two perspective views, a back view, a close-up of a back view, a front view, and a close-up of a front view, respectively, of the lighting module 1300 in an assembled state.

The perspective views of FIG. 35 show the lighting module 1300 from the back side (under (a)), and from the front side (under (b)). The perspective view from the front side (under (b)) clearly shows that each cup 1351 of the cup plate 1350 holds one lens cluster 1341 of four lenses arranged in a 2-by-2 matrix.

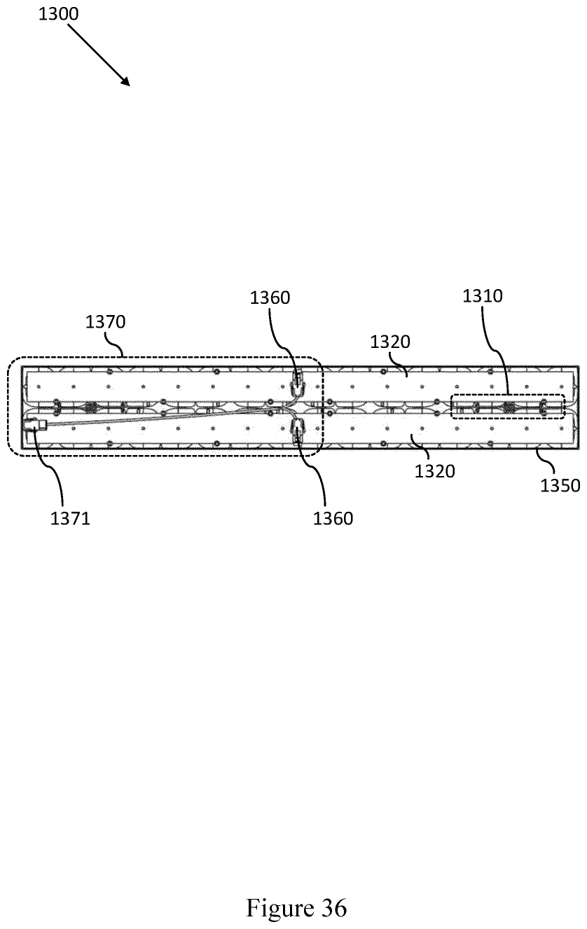

The connector elements 1360 are connected to the substrate tabs 1335. The latter are no longer clearly visible in the views of FIGS. 35 and 36 and have therefore not been labelled with a reference numeral.

In turn, the connector elements 1360 have been connected to the connector module 1370. The cable of the connector module 1370 extends from the location of the connector elements 1360 in a direction parallel to an elongation direction of the lighting module 1300 to an edge of the lighting module 1300. At this edge of the lighting module 1300, the connector module 1370 has a lighting module plug 1371. This edge may therefore also be referred to as the connector side of the lighting module 1300.

For detaching a lighting module 1300 from the back plate 1100, the connector side is preferably detached first. For this purpose, the connector side may be marked. For example, the lighting module 1300 may have a cutout (or indent) at the connector side to mark the location of the connector side and to enable easy detachment by means of a tool, such as a screwdriver.

Each base substrates 1330 is arranged between a metal plate 1320 and the cup plate 1350. The base substrates 1330 are no longer clearly visible in the views of FIGS. 35, 36 and 38 and have therefore not been labelled with a reference numeral.

Each of the springs 1310 is in a relaxed state, being a resting state wherein substantially no stretch or compression exists. In such a relaxed state, the legs of the spring 1310 extend outwards from the coil, in directions parallel to an elongation direction of the lighting module 1300.

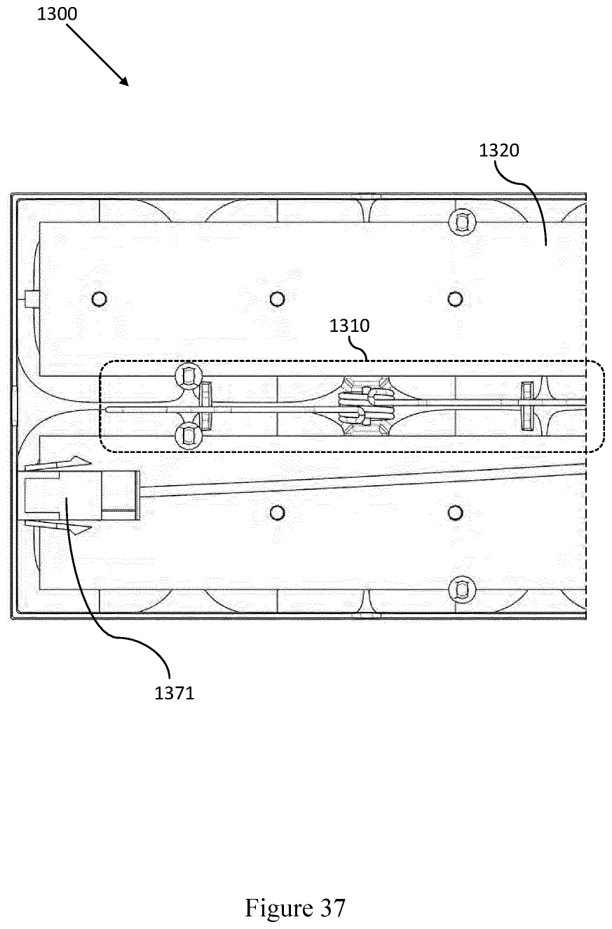

FIG. 37 shows a close-up of the view of FIG. 36, showing the connector side of the lighting module 1300.

In the close-up view of FIG. 37, it can be seen that the spring 1310 has a double bend where the legs connect to the coil. Such a double bend allows for a more stable behavior of the spring 1310.

In the close-up view of FIG. 37, it can further be seen that the cable and lighting module plug 1371 of the connector module 1370 are arranged in such a way as to provide sufficient space for the spring 1310.

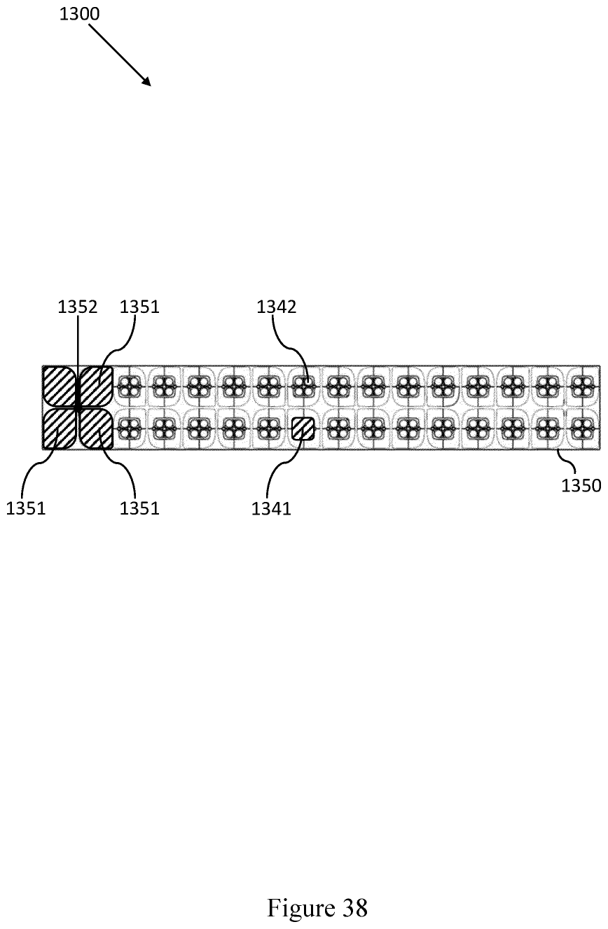

The front view of FIG. 38 clearly shows the cup plate 1350, with 32 reflective cups 1351 arranged in a 2-by-16 matrix (four such cups 1351 are each indicated with a hatched area), each cup 1351 having at its base, a lens cluster 1341 (one such cluster 1341 is indicated with a hatched area) of four lenses 1342 arranged in a 2-b-2 matrix.

Each cup 1351 has a shape that resembles a rhomboid leaf shape. In the cup plate 1350, clusters of four such cups 1351 can be identified, wherein for each cluster the cups 1351 are arranged around a central point 1352 so as to form a rotationally symmetric cup arrangement.

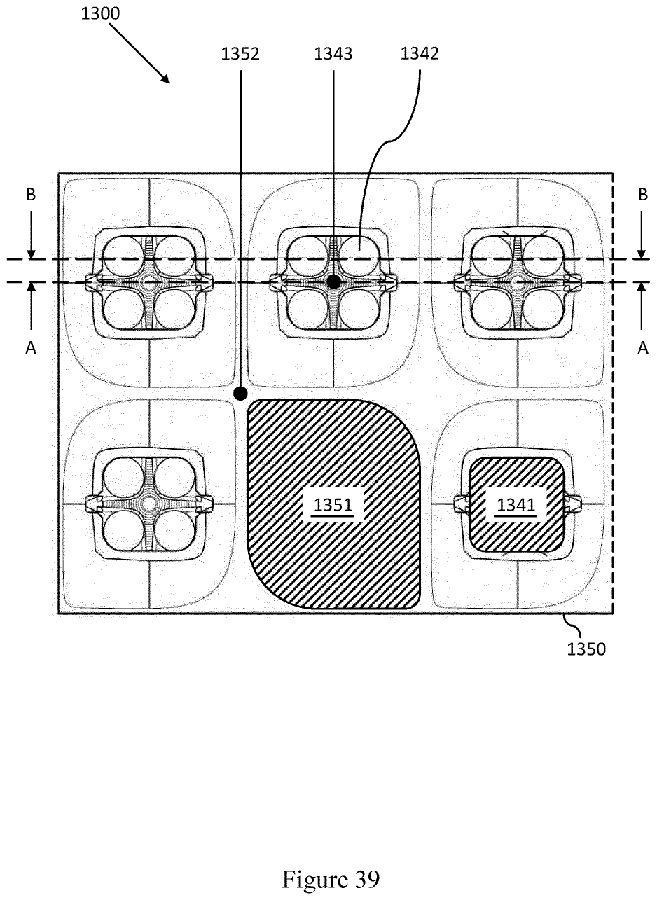

FIG. 39 shows a close-up of the view of FIG. 38.

The close-up view of FIG. 39 shows axes A and B, both oriented parallel to the elongation direction of the lighting module 1300. Axis A passes through the centers of the lens clusters 1341 that belong to the same lens array 1340, and axis B passes through the centers of the lenses 1342 that are located on the same side next to axis A.

In the close-up view of FIG. 39, it can further be seen that, in each lens cluster 1341, the four lenses 1342 are separated from each other by means of a wall structure 1343, which may be a separate element or an integral part of the lens array 1340.

Because each lens cluster 1341 has four lenses 1342 arranged in a 2-by-2 matrix, the wall structure 1343 has a cross shape. For any other arrangement of multiple lenses in a lens cluster, the wall structure may have a different shape, as long as the wall structure is capable of separating any individual lens from the other lenses in the lens cluster.

The wall structure 1343 is arranged such that each lens 1342 is separated from each other lens 1342 by a section of the wall structure 1343.

At least these sections of the wall structure 1343, but optionally also the whole wall structure 1343, is translucent (such as transparent) or reflective for light emitted by the LEDs 1332.

The sections of the wall structure 1343 separating the lenses 1342 may have a height that is smaller than, or equal to, or larger than the height of the lenses 1342.

The purpose of the wall structure 1343 is to overcome certain optical issues that would otherwise result from positioning LEDs in clusters.

For example, a LED cluster represents an extended light source, and when associated with a lens cluster and provided in a cup-shaped reflector, cut-offs may be different and asymmetric for every combination of a LED (of the LED cluster) and a lens (of the lens cluster). This may lead to insufficient cut-off (when a LED is located too far away from a side of the reflector cup) or too much light loss (when a LED is located too close to a side of the reflector cup).

Also, an LED cluster associated with individual lenses may create, inside the reflector cup, a relatively strong inhomogeneous luminance profile of relatively bright points separated by relatively dark areas in between the lenses. For improved comfort, such contrast between the LEDs may be reduced.

The above optical issues may be overcome by the wall structure 1343.

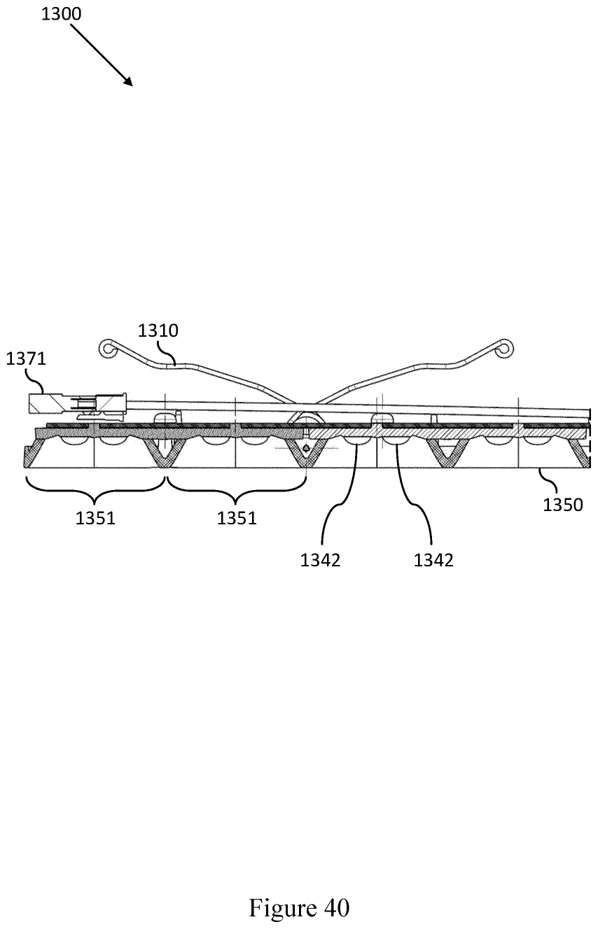

FIGS. 40 and 41 are cross sections of the lighting module 1300 along axes A and B (shown in FIG. 39 respectively.

The cross section of FIG. 40 shows the individual lenses 1342 and alignment points.

The cross section of FIG. 41 shows the dome-like shape of the individual lenses 1342, and the LEDs 1332 that are provided on the base substrate 1330.

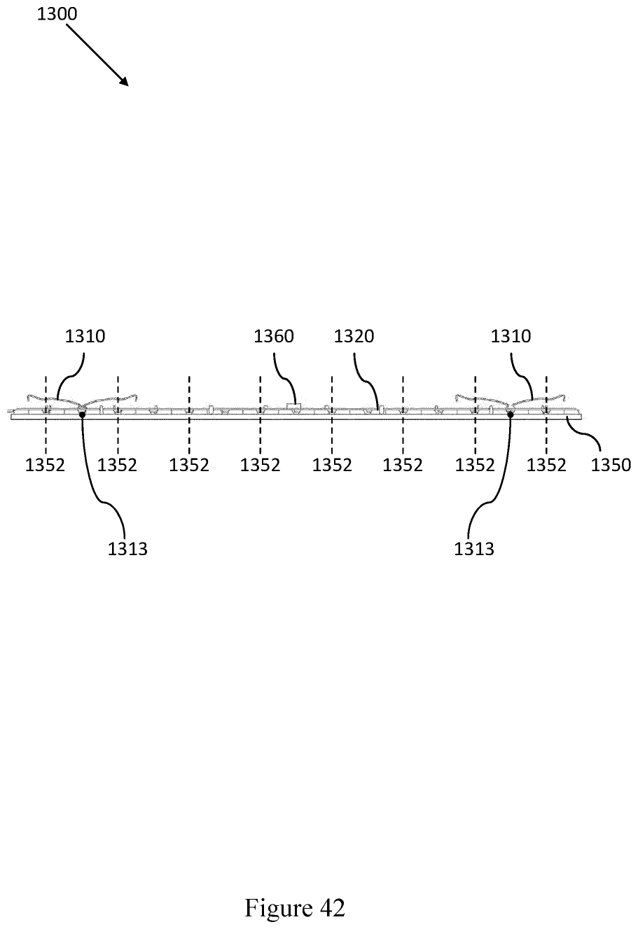

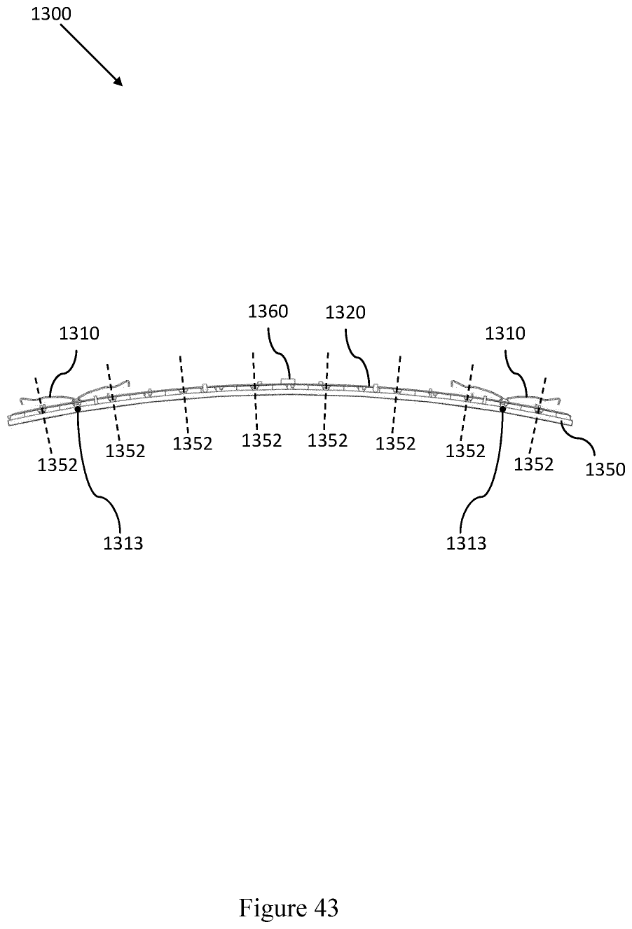

FIGS. 42 and 43 are side views of the lighting module 1300 in an assembled state.

In the side view of FIG. 42, the hatched lines labelled 1352 indicate the positions of the central points around which four cups 1351 are arranged to form a rotationally symmetric cup arrangement.

The side view of FIG. 43 shows the lighting module 1300 in an (exaggerated) bent or curved configuration. Such a pre-bent or pre-curved configuration has the advantage that, once assembled in the luminaire 1000, a good thermal contact can be made between the lighting module 1300 (via the metal plates 1320) and the back plate 1100. Furthermore, a pre-bent or pre-curved configuration ensures that the thermal contact is maintained even when the luminaire 1000 is mounted to a ceiling and subjected to the force of gravity.

In the views of FIGS. 35 to 43, the springs 1310 are in their relaxed states, being resting positions wherein a minimum amount of stretch or compression, or even substantially no stretch or compression, exists. In its relaxed state, the legs of the spring 1310 extend outwards from the coil, in directions parallel to an elongation direction of the lighting module 1300.

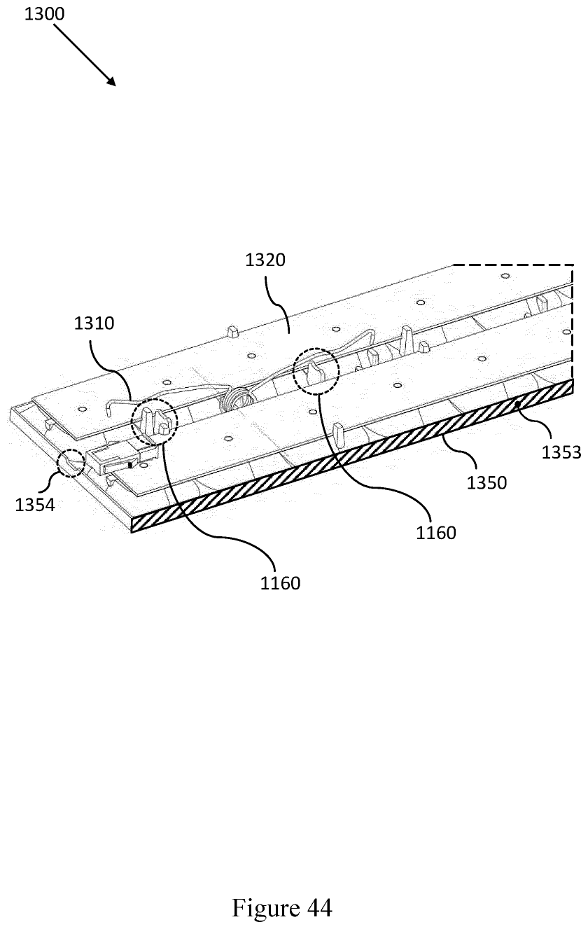

FIG. 44 shows a close-up of the perspective view under (a) of FIG. 35, to even better illustrate the relaxed state of the spring 1310.

In a relaxed state, each leg of the spring 1310 may rest upon a stud 1160. This enables a user to bring the spring 1310 from a relaxed state into a tensioned state by using only one hand.

FIG. 44 also shows that the lighting module 1300 has a rim 1353, which may go all around the perimeter of the lighting module 1300, and which may be an integral part of the cup plate 1350. In FIG. 44, part of the rim 1353 is indicated with a hatched area.

The rim 1353 provides the lighting module 1300 with sufficient stiffness. The rim 1353 may also serve to provide guidance to the position of the lighting module 1300 when the latter is inserted into the luminaire 1000. Such guidance function may be further improved by adding a slope to the rim 1353.

The rim 1353 of the lighting module 1300 may have a cutout 1354, to provide a location for insertion of a tool, such as a screwdriver, for detaching the lighting module 1300 from the back plate 1100 of the luminaire 1000. When the cutout 1354 is provided at the connector side of the lighting module 1300 (as is the case in the view of FIG. 44), it is ensured that detachment of the lighting module is first done at the connector side, which may be preferred.

Together with a careful process optimization, the rim 1353 may further serve to provide a pre-bending of the lighting module 1300, such as shown in FIG. 43.

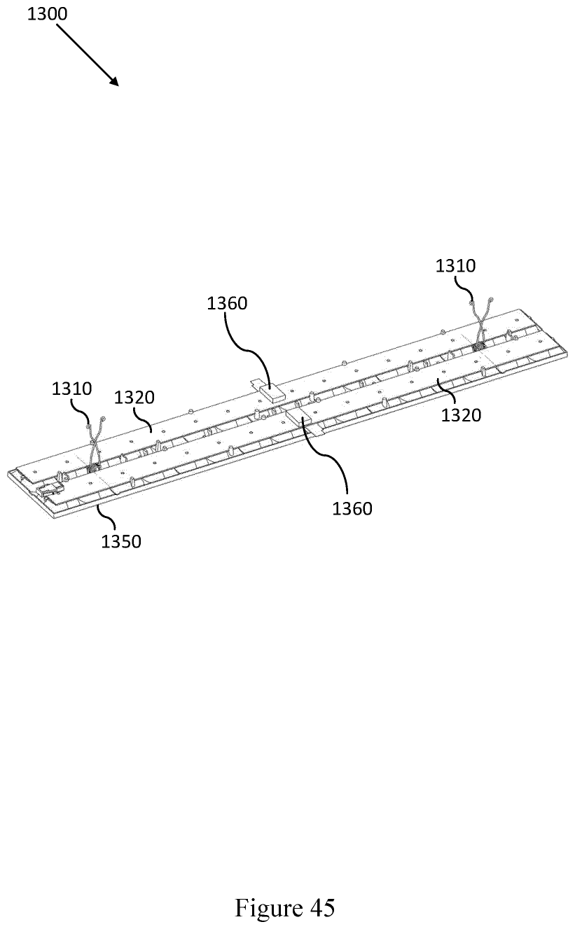

FIG. 45 is a perspective view of the lighting module 1300 in an assembled state, similar to the view of FIG. 35, but now with the springs 1310 in a tensioned state.

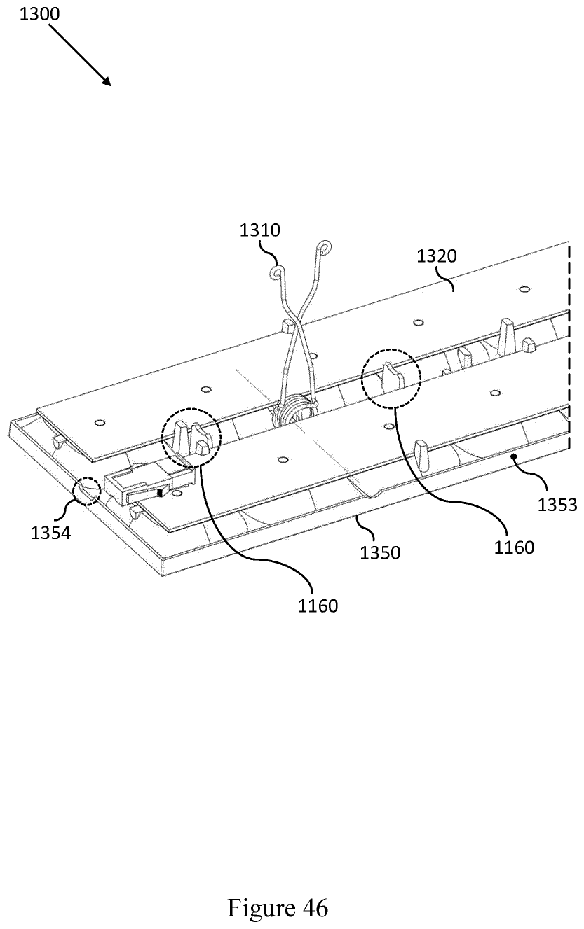

FIG. 46 shows a close-up of the view of FIG. 45 to even better illustrate the tensioned state of the spring 1310.

In this tensioned state, the legs of the spring 1310 extend from the coil in a direction away from the lighting module 1300.

Such a tensioned state allows the legs of the spring 1310 to be inserted into the back plate 1100 via a spring mounting opening 1113. After such insertion, the spring 1310 can return to its relaxed state so that the legs press against a back surface of the back plate 1100, thereby keeping the lighting module 1300 in place and ensuring (thermal) contact between the metal plates 1300 and a front surface of the back plate 1100.

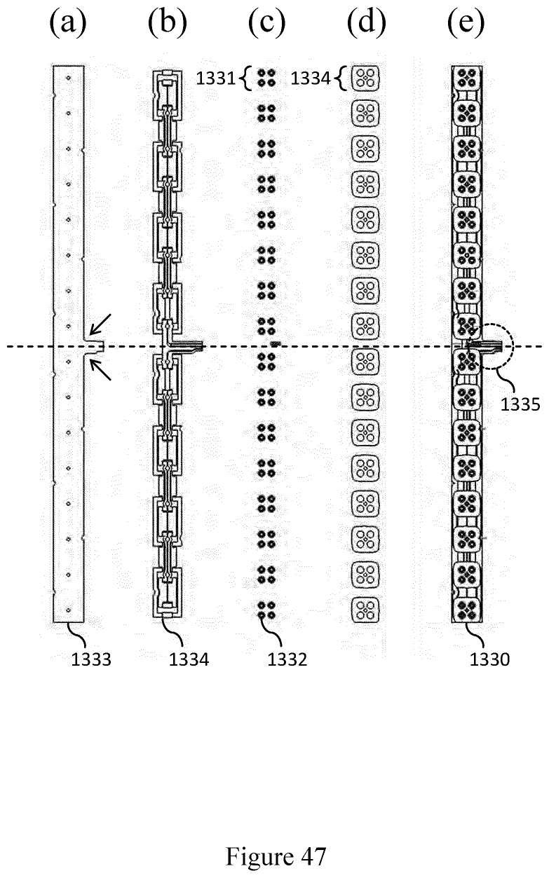

FIG. 47 shows the components that make up a base substrate 1330.

Under (a), FIG. 47 shows an electrically insulating layer 1333, for use as carrier of the electrically conductive traces. The electrically insulating layer 1333 may be made from any suitable electrically insulating material, such as polyethylene terephthalate (PET).

Under (b), FIG. 47 shows a pattern of electrically conductive traces 1334.

Under (c), FIG. 47 shows an arrangement of 64 LEDs 1332, comprising 16 LED clusters 1331 of four LEDs 1332 per LED cluster 1331, the four LEDs 1332 being arranged in a 2-by-2 matrix. For the sake of clarity, only one LED 1332 and only one LED cluster 1331 are indicated with reference numerals.

Under (d), FIG. 47 shows a pattern of 16 reflective areas 1334, each reflective area 1334 being associated with a corresponding LED cluster 1331. For the sake of clarity, only one reflective area 1334 is indicated with a reference numeral. The reflective areas 1334 have a relatively high reflectivity for light emitted by the LEDs 1332. To avoid unnecessary material usage, the reflective areas 1334 may be provided only at the locations of the LED clusters 1331.

Under (e), FIG. 47 shows the components that are individually illustrated under (a) to (d) on top of each other, thereby forming the base substrate 1330.

In FIG. 47, the horizontal dashed line indicates the position of the substrate tab 1335, which is located substantially halfway the length of the base substrate 1330.

Under (a), the two arrows point towards rounded connections on both sides of the substrate tab 1335 to the base substrate 1330. Such rounded connections are for preventing stress that may otherwise occur in the base substrate 1330, especially if the electrically insulating layer 1333 is a flex foil.

The pattern of electrically conductive traces 1334 has four loops. Each loop starts and ends at the position of the substrate tab 1335. Two of the four loops are provided on one side of the position of the substrate tab 1335, and the remaining two loops are provided on the other side of the position of the substrate tab 1335. In other words, the pattern of electrically conductive traces 1334 has two sets of two loops per set, meeting at a point in the middle of the pattern. Each set of two loops has an inner loop and an outer loop, wherein the outer loop goes around the inner loop. Because an outer loop will be longer than an inner loop, the inner and outer loops may have different power losses due to differences in electrical resistance. Any such mismatch may be compensated by designing the electrical traces of the outer loops to be wider than those of the inner loops. Alternatively or additionally, the LEDs may be positioned such as to balance the LED strings formed by the inner and outer loops.

The above configuration allows the use of a single connector element 1360 (not shown in FIG. 47 for making a connection to the electrically conductive traces, while minimizing the total length of the electrically conductive traces.

The layout of the base substrate 1330, in particular the arrangement of the electrical traces 1334 and the LEDs 1332, may be such that the shortest possible parallel LED strings are obtained. Such arrangement may require one or more crossovers in the electrical connections.

The electrical traces 1334 may be provided by any suitable technique. In case the electrical traces 1334 are in the form of printed electronics, providing crossovers in the electrical connections may be relatively difficult. Instead, an additional connection may be provided, such that, for example, one 42 V connection and two ground connections are present instead of one ground connection. These three connections per base substrate 1330, or six connections per lighting module 1300, can be combined into two wires (one 42 V wire and one ground wire).

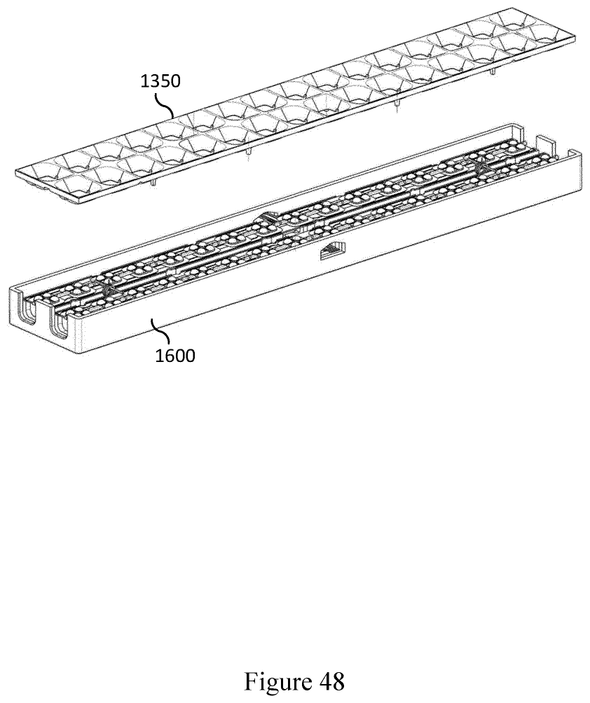

FIG. 48 shows an assembly tool 1600 that can be used to assemble the lighting module 1300.

In FIG. 48, all components of the lighting module 1300 except the cup plate 1350 are provided in the assembly tool 1600.

The assembly tool 1600 may be designed such that, when used to assemble the lighting module 1300, it provides the latter with a bent or curved shape such as illustrated in FIG. 43.

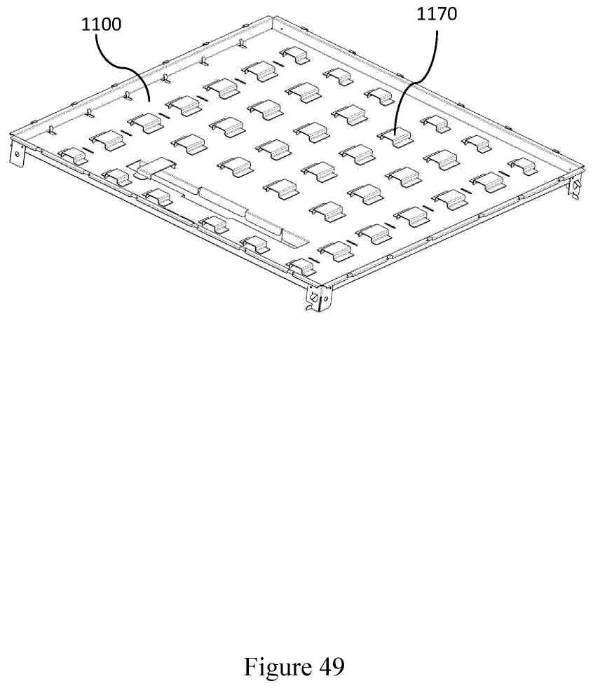

FIG. 49 shows an alternative version of the back plate 1100, wherein brackets 1170 are provided on the surface of the back plate 1100 that, in the luminaire 1000, faces the lighting modules 1300.

The brackets 1170 may be made from sheet metal.

The brackets 1170 take the place of the dimples 1150 as shown in some of the previous figures. As did the dimples 1150, the brackets 1170 serve to strengthen the back plate 1100, while at the same time acting as spacers and heat dissipation elements.

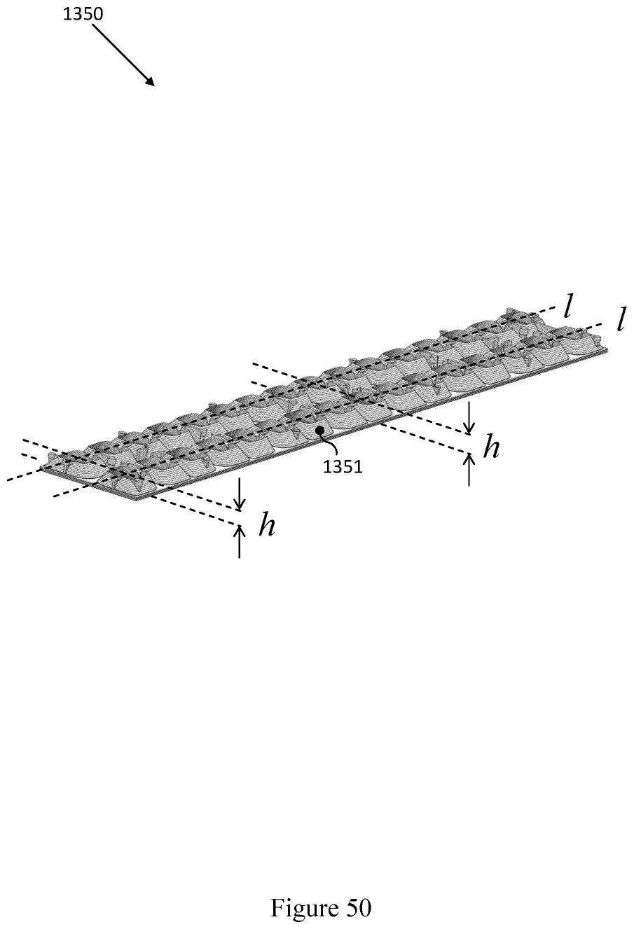

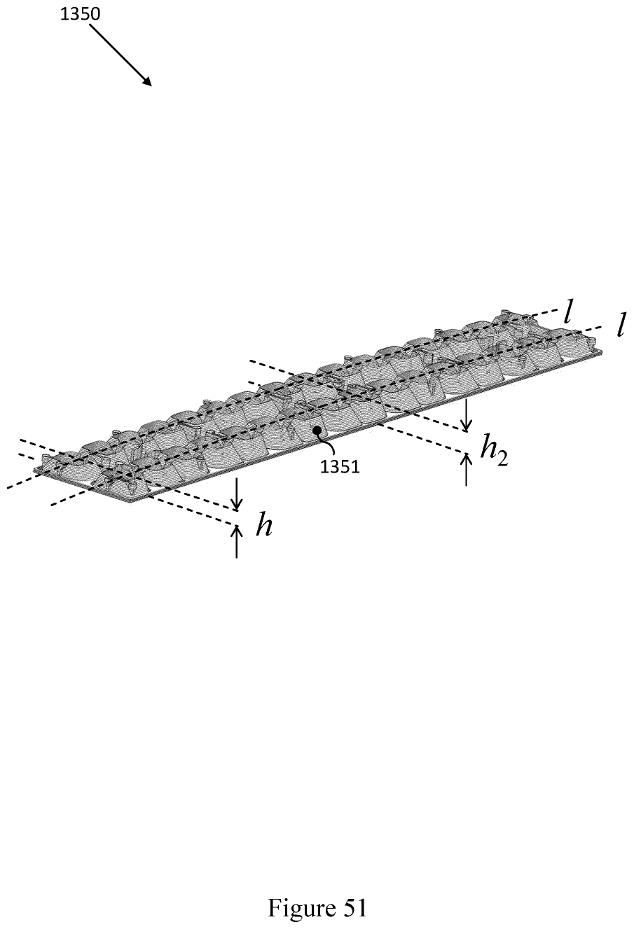

FIGS. 50 and 51 each show a perspective view of a cup plate 1350 that has been manufactured by means of 3D printing. The cup plates 1350 are printed such that the cups 1351 extend in the printing direction.

In particular, the cup plates 1350 shown in FIGS. 50 and 51 have been made by means of fused deposition modeling (FDM), which is also called fused filament fabrication (FFF) or filament 3D printing (FDP). This is one of the most commonly used forms of 3D printing.

In an FDM process, a 3D printer creates an object in a layer-by-layer manner by extruding a printable material (typically a filament of a thermoplastic material) along tool paths that are generated from a digital representation of the object.

The printable material is heated just beyond solidification and extruded through a nozzle of a print head of the 3D printer. The extruded printable material fuses to previously deposited material and solidifies upon a reduction in temperature.

In a typical 3D printer, the printable material is deposited as a sequence of planar layers onto a substrate that defines a build plane. The position of the print head relative to the substrate is then incremented along a print axis (perpendicular to the build plane), and the process is repeated until the object is complete.

The 3D printed cup plate 1350 illustrated in FIGS. 50 and 51 is an alternative for a cup plate 1350 that has been made by means of injection molding.

The 3D printed cup plate 1350 may be made from a material that has a relatively high reflectivity for light emitted by the LEDs 1332, such as polycarbonate.

The cup plate 1350 may be designed such that it can be printed by means of a single tool path representing a continuous loop, thereby optimizing the printing time.

The cup plate 1350 may be designed as a combination of two parts, a first part representing a frame section of the cup plate 1350 and a second part representing a cup section of the cup plate 1350.

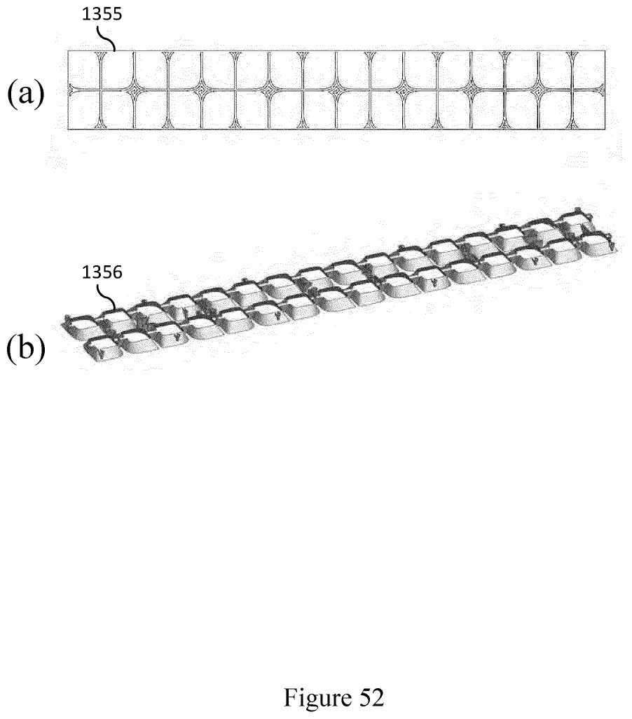

An example of a tool path 1355 for the first part (i.e., the part representing a frame section of the cup plate 1350) is shown in FIG. 52, under (a). The tool path 1355 is in the form of a continuous loop and it is designed such as to ensure that no gaps or defects are present on the face of the part which contacts the build plate during printing, and it is designed to ensure that the perimeter walls of the part are relatively straight and the areas between the cups are filled with material.

An example of a tool path 1356 for the second part (i.e., the part representing a cup section of the cup plate 1350) is shown in FIG. 52, under (b). To be able to print continuously without having to stop and start the extrusion process, any features on the rear of the second part may be created by looping the path outside of the cups 1351 at various points. Although this may lead to seams on walls or surfaces of the cups 1351, the design may be optimized so as to minimize such defects so that during operation of the luminaire 1000 they will not be visible.

The 3D printed cup plate 1350 may have one or more integrated features to provide additional functionality. Examples of such integrated features are a board fixation feature for a Zhaga standard board fixation, a cable routing and holding feature, a lens clamping feature to minimize optical losses between the base substrate 1330 and the 3D printed cups 1351, and a spring fixation feature for fixation of the spring 1310.

A lens clamping feature can be integrated in the form of a recess for clamping the bar-shaped connectors of two adjacent lens clusters 1341.

Compared to the cup plate 1350 of FIG. 50, the cup plate 1350 of FIG. 51 has cups 1351 of varying height. The height of the cups 1351 increases as the cups 1351 are closer to the center of the cup plate 1350.

In FIG. 50, all cups 1351 have substantially the same height h, so that a line l that connects the bases of the cups 1351 is a straight line.

In FIG. 51, the cups 1351 furthest away from the center of the cup plate 1350 have a height h₁, while towards the center of the cup plate 1350 the height of the cups 1350 gradually increases to h₂, being larger than h₁, so that a line l that connects the bases of the cups 1351 is a curved line.

When used as component of a lighting module 1300, the cup plate 1350 shown in FIG. 51 provides the lighting module 1300 with a pre-bent or pre-curved configuration similar to the configuration illustrated in FIG. 43. As already mentioned in the context of FIG. 43, such a pre-bent or pre-curved configuration of a lighting module 1300 has the advantage that, once assembled in the luminaire 1000, a good thermal contact can be made between the lighting module 1300 (via the metal plates 1320) and the back plate 1100, and that the thermal contact is maintained even when the luminaire 1000 is mounted to a ceiling and subjected to the force of gravity.

The configuration of the luminaire 1000 as described with reference to FIGS. 1 to 52 enables two such luminaires 1000 to be packed in a back-to-back configuration for use during transport.

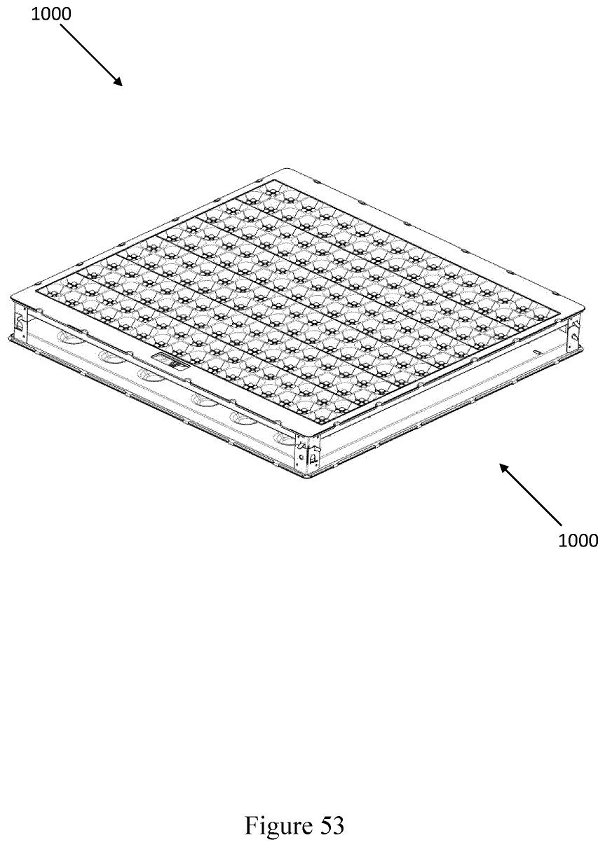

FIG. 53 is a perspective view of two luminaires 1000 in such a back-to-back packing configuration.

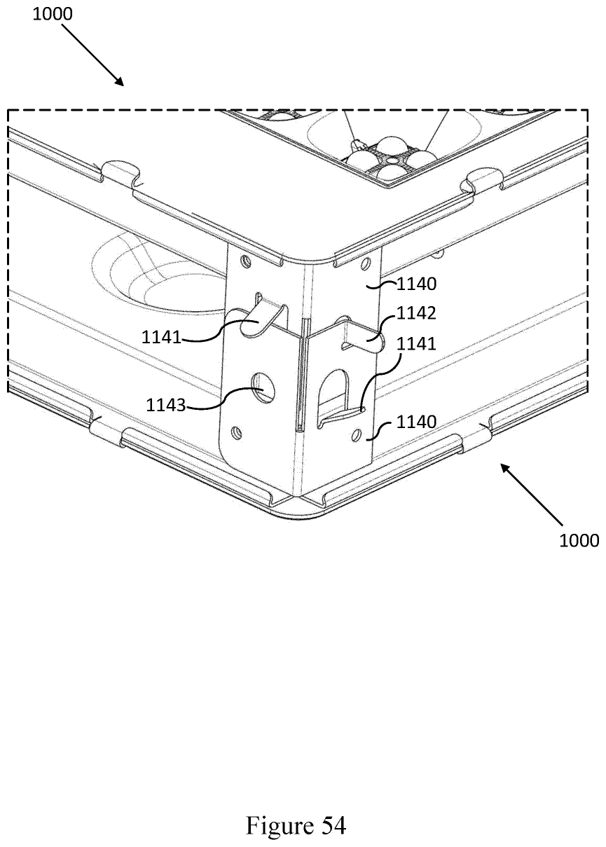

FIG. 54 is a close-up of the view of FIG. 53, showing a corner of the back-to-back packing configuration.

Each luminaire 1000 has, at one or more of its corners, a mounting means 1140 that may be used to mount the luminaire 1000 in a T-grid ceiling system.

The close-up view of FIG. 54 shows two such mounting means 1140, each belonging to a different luminaire 1000. Each mounting means 1140 has a first clip 1141, a second clip 1142, and a cable connection 1143. The first clip 1141 and the second clip 1142 may be used as bottom and top clips, respectively, for connecting the luminaire 1000 to a T-grid ceiling system. The cable connection 1143 may be used as connection for an earthquake cable.

These mounting means 1140 can also be used as positioning means for two luminaires 1000 in a back-to-back packing configuration, as illustrated in the close-up view of FIG. 53, wherein a first mounting means 1140 of a first luminaire 1000 interacts with a second mounting means 1140 of a second luminaire 1000. In particular, a first clip 1141 of a first mounting means 1140 of a first luminaire 1000 slides over a second mounting means 1140 of a second luminaire 1000 to fix the two luminaires in position relative to each other.

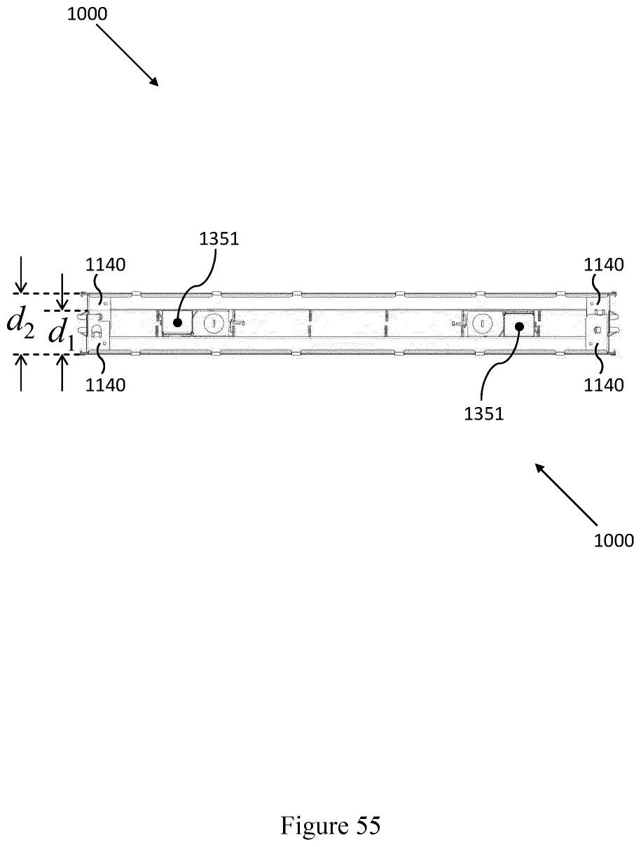

FIG. 55 is a side view of two luminaires 1000 in a back-to-back packing configuration. In this view it can be seen that the drivers 1400, that each protrude from a back plate 1100 of a respective luminaire 1000, are positioned in a mutually opposite configuration.

The total height of this back-to-back packing configuration is d₂, while that of a single luminaire 1000 is d₁. The ratio d₂/d₁ is less than 2, typically less than 1.5, such as about 1.4, or even less than 1.4, thereby indicating the space saving ability of the packing configuration. For example, a single luminaire 1000 may have a height of about 50 mm, while the total height of two such luminaires 1000 in a back-to-back packing configuration is about 70 mm. This corresponds to a space saving of about 30%. In other examples, the space saving may even be up to 35%.

The person skilled in the art realizes that the invention is by no means limited to the embodiments described above. On the contrary, many modifications and variations are possible within the scope of the appended claims.

1. A luminaire comprising one or more lighting modules and a driver for driving the one or more lighting modules,
wherein the luminaire further comprises a luminaire housing, the one or more lighting modules and the driver being arranged in the luminaire housing,
wherein the luminaire housing comprises a back plate constituting a back side of the luminaire housing, each lighting module and the driver being releasably connected to the back plate and the back plate (1100) having an opening arranged to accommodate the driver
wherein the luminaire further comprises a junction box, the driver having a low-voltage side that can be connected to the back plate and a high-voltage side that can be connected to the junction box,
wherein the luminaire further comprises a cover,
wherein, when the driver is connected to the back plate, a first part at the low-voltage side is covered by the cover and a second part at the high-voltage side is inserted in the junction box, the cover, the junction box, and a remaining third part of the driver, located between the first part and the second part, together providing a closure of the opening,
wherein, at the low-voltage side, the driver is arranged to be connected to the cover by means of a releasable connection, and
wherein, after disconnecting the releasable connection at the low-voltage side, the driver is arranged to be moved in a direction from the low-voltage side towards the high-voltage side so that the driver slides into the junction box, thereby creating space at the low-voltage side to allow the driver to be tilted away from the back plate.

2. The luminaire according to claim 1, wherein the driver comprises a driver housing, and wherein the back plate and the driver housing are both made from a metal.

3. (canceled)

4. The luminaire according to claim 3, wherein, when connected to the back plate, the driver is kept in position by an assembly bridge.

5. The luminaire according to claim 4, wherein the assembly bridge is arranged to prevent a drop of the driver when the low-voltage side of the driver is detached from the back plate.

6. The luminaire according to claim 4, wherein the luminaire comprises a plurality of lighting modules, each lighting module having a base substrate, wherein the back plate has a plurality of dimples for aligning the plurality of lighting modules so that the base substrates are in a plane at a distance from the back plate, wherein a first lighting module of the plurality of lighting modules is arranged to cover the driver, and wherein the assembly bridge is arranged to align the first lighting module so that the base substrate of the first lighting module is in the plane.

7. The luminaire according to claim 6, wherein the assembly bridge is arranged to dissipate heat away from the first lighting module when the luminaire is in operation.

8. (canceled)

9. (canceled)

10. The luminaire according to claim 1, wherein the back plate has one or more lips for clamping to a side of the driver when the driver is connected to the back plate.

11. The luminaire according to claim 10, wherein the back plate has a first lip that is located approximately at a center of the opening, and wherein the first lip is oriented at an acute angle relative to the back plate, thereby providing a space for allowing a user to grasp the driver when the driver is arranged in the opening of the back plate.

12. The luminaire according to claim 11, wherein the back plate has a second lip that is located adjacent to the first lip, wherein the second lip is oriented at a substantially right angle relative to the back plate, thereby providing a surface for clamping a side of the driver when the driver is arranged in the opening of the back plate.

13. The luminaire according to claim 1, wherein the luminaire further comprises a front rim constituting a front side of the luminaire housing.
